(19) United States
(12) Patent Application Publication
(10) Pub. No.: US 2023/0232919 A1
(43) Pub. Date: Jul. 27, 2023

(54) SURFACE COATING COMPRISING MICROFIBRILLATED CELLULOSE OR NANOCELLULOSE

(71) Applicants: FIBERLEAN TECHNOLOGIES LIMITED, PAR (GB); THE UNIVERSITY OF BIRMINGHAM, Birmingham (GB); CAMBRIDGE ENTERPRISE LTD, Cambridge (GB)

(72) Inventors: Zhenyu ZHANG, Birmingham (GB); Peter Robert FRYER, Birmingham (GB); Shaojun QI, Birmingham (GB); Ioannis KIRATZIS, Birmingham (GB); Stuart CLARKE, Cambridge (GB); David SKUSE, Truro (GB)

(21) Appl. No.: 18/076,453

(22) Filed: Dec. 7, 2022

(30) Foreign Application Priority Data
Dec. 9, 2021 (GB) 2117810.8
Mar. 21, 2022 (GB) 2203925.9

(51) Int. Cl. A41D 13/11; C09D 7/63; C09D 7/61; C09D 7/20; C09D 101/08; C08L 1/08

(52) U.S. Cl. CPC A41D 13/1192; C09D 7/63; C09D 7/61; C09D 7/20; C09D 101/08; C08L 1/08; C08L 2201/10; C08L 2203/02; C08L 2203/16

(57) ABSTRACT

Articles comprising a surface or porous substrate and having on said surface or porous substrate a coating comprising microfibrillated cellulose or nanocellulose, methods of applying a coating comprising microfibrillated cellulose or nanocellulose to a surface or porous substrate, compositions comprising microfibrillated cellulose or nanocellulose, and the use of such compositions in methods of preparing an antimicrobial surface coating, and improving filtration efficiency and preparing an antimicrobial surface and/or antiviral surface coating.

### CROSS-REFERENCE TO RELATED APPLICATIONS

This application claims benefit under 35 U.S.C. § 119 of Great Britain patent application no. 2117810.8, filed Dec. 9, 2021, and titled “SURFACE COATING COMPRISING MICROFIBRILLATED CELLULOSE,” and Great Britain patent application no. 2203925.9, filed Mar. 21, 2022, and titled “POROUS SURFACE COATING COMPRISING NANOCELLULOSE,” the contents of which are incorporated herein by reference in their entirety.

### FIELD OF INVENTION

Articles comprising a surface or porous substrate and having on said surface or porous substrate a coating comprising microfibrillated cellulose or nanocellulose, methods of applying a coating comprising microfibrillated cellulose or nanocellulose to a surface or porous substrate, compositions comprising microfibrillated cellulose or nanocellulose, and the use of such compositions in methods of preparing an antimicrobial and/or antiviral surface coating.

### BACKGROUND OF THE INVENTION

Severe acute respiratory syndrome coronavirus 2 (SARS-CoV-2), responsible for the global pandemic of coronavirus disease 2019 (COVID-19), belongs to the family of ‘enveloped viruses’ along with influenza viruses and the also lethal 2002 severe acute respiratory syndrome coronavirus 1 (SARS-CoV-1) and the 2011 Middle East respiratory syndrome coronavirus (MERS-CoV). In vitro SARS-CoV-2 virions are often wrapped within respiratory droplets and aerosols generated by a diseased person via coughs, sneezes, talking or simply breathing, making them highly contagious, particularly in enclosed spaces. Transmission of SARS-CoV-2 can thus occur through direct exposure to respiratory droplets (>5-10 μm) or aerosols (≤5 μm) that include virus. Surface transmission is considered a likely mode by the scientific community and public health authorities. It takes place by contact with fomite surfaces that were contaminated by infectious respiratory secretions or droplets. SARS-CoV-2 RNA has been widely detected on high-touch surfaces such as handles (e.g. door handles or trash can handles), handrails, shared sanitation facilities in hospitals, schools and community settings, recently cold chain surfaces, etc. Viable SARS-CoV-2 were found on those surfaces for periods ranging from hours to days. Therefore, one of the primary intervention measures adopted by countries and territories around the world amid the COVID-19 pandemic is frequent cleaning and disinfection of communal surfaces.

Possible routes for reducing surface transmission of viruses such as SAR-CoV-2 include (a) chemical disinfection, (b) non-contact disinfection and (c) antiviral coatings. Chemical detergents, such as chlorine bleach, phenolics and quaternary ammonium compounds have been reported as rapid solutions for disinfection of virus contaminated surfaces. Such detergent-based agents inactivate viruses by disrupting the lipid envelop of the virion. However, they normally do not provide long lasting protection to the surface, and the concerns over their environmental impact and cytotoxicity limit their regular use in settings such as households and offices. The current practice of large-scale, frequent, indiscriminate and sometimes more-than-needed application of disinfectants amid COVID-19 is worrying, posing threats to the urban environment, biodiversity and the public health.

Non-contact disinfection can be delivered from a distance via various energy sources. SARS-CoV-2 has been found to be stable at 4° C. but very sensitive to heat. It has been shown to be possible to disinfect personal protective equipment (PPE), including N95 masks by gently heating at 70° C. and 0% relative humidity for 1 hour. Heat inactivation was also achieved by incubating SARS-CoV-2 stock at 80° C. for 1 hour. Thermal inactivation is, however, not flexible as it requires heating equipment which requires investment and there are limitations on the dimensions of the objects that can be treated.

Since the beginning of the pandemic caused by SARS-CoV-2 in 2020, it was recommended by authorities across the world that wearing of face masks is a very important measure, alongside social distancing and good hygiene to mitigate the transmission of virus via aerosol. Despite a global shortage of medical grade face mask at the beginning of the pandemic, disposal ones became widely available to the general public for one time usage, which leads to a severe environmental concern as the amount of non-woven fabrics accumulates in the ecosystem is challenging to handle, and can result in microplastics pollution in both marine and freshwater systems.

Recent study estimates that we use an astounding 129 billion face masks globally every month, which equals to 3 million a minute. The environmental impact of surgical mask, based on non-woven fabrics, has become a great concern to environmental scientists.

The benefit of non-woven fabrics that are made of polypropylene (PP) are twofold: 1. low porosity to block the aerosol droplets; 2. electrostatic charge applied to the PP fibres to adhere small aerosol nuclei. It is not possible to re-use a face mask based on non-woven fabric because the surface charge will be neutralised by the detergent during the washing cycle.

The detrimental impact of surgical mask to the environment could be addressed by applying a cellulose film that is less than 1 μm onto textile, to improve the filtration efficiency of ordinary textile.

As a sustainable solution, face masks (coverings) based on ordinary textile such as cotton and polyester do not provide a satisfactory filtration efficiency, as evidenced by a number of scientific publications. This inefficiency can significantly compromise the protection purpose of face masks for the general public, especially those who are vulnerable to respiratory disease.

Antiviral surfaces offer a passive approach against harmful pathogens, including coronaviruses. Naturally occurring antiviral surfaces, for example, are found on specific herbs containing antiviral inhibitors such as myricetin, scutellarein and phenolic compounds which destroy viruses upon contact. Engineered surface coatings incorporating selected metal elements, notably copper and silver, have shown satisfactory virucidal properties by disrupting the disulphide bonds of virus proteins and/or releasing reactive oxygen species (ROS) that damage the nucleic acids of the virus. Another group of antiviral materials, and the probably most popular ones, include quaternary ammonium compounds (QACs). The positively charged groups and lipophilic tails on QACs can readily bond to and disrupt negatively charged virus envelopes, conferring a good inactivation efficiency provided the QAC structure matches the lipid composition and envelope protein density of the targeted virus.

The conventional strategies for antiviral surfaces have been primarily focused on modifying surfaces with chemical compounds which target directly the virus membrane. However, each of these approaches has their associated drawbacks, not least that they target a virus membrane which is often not what is in direct contact with the surface in question (for example, in the case of virions that are wrapped within respiratory droplets and aerosols).

Notwithstanding the foregoing technologies, there remains a need for easily manufactured and readily available antimicrobial products that reduce or prevent the transmission of infectious disease such as SARS-CoV-2.

### SUMMARY OF THE INVENTION

A first aspect of the invention provides an article comprising a surface and having on said surface a coating comprising at least about 80 wt % microfibrillated cellulose based on the total weight of the coating.

A second aspect of the invention provides an article comprising a non-porous surface and having on said surface a coating comprising microfibrillated cellulose.

A third aspect of the invention provides a method of applying a coating to a surface, the method comprising:
(i) treating the surface with a composition comprising a suspension of microfibrillated cellulose in a liquid component comprising water and optionally a water miscible component; and
(ii) obtaining a surface coated with a coating comprising microfibrillated cellulose.

A fourth aspect of the invention provides a composition comprising a suspension of microfibrillated cellulose in a liquid component comprising water and optionally a water miscible component.

A fifth aspect of the invention provides a method of applying a coating to a surface, the method comprising (i) treating the surface with a composition according to the fourth aspect of the invention; and (ii) obtaining a surface coated with a coating comprising microfibrillated cellulose.

A sixth aspect of the invention provides an article comprising a surface coated with a coating applied according to the methods of the third or fifth aspects of the invention.

A seventh aspect of the invention provides an article comprising a surface coated with the composition of the fourth aspect of the invention.

An eighth aspect of the invention provides the use of a composition according to the fourth aspect of the invention in a method of preparing an antimicrobial surface coating.

A ninth aspect of the invention provides the use of microfibrillated cellulose for inactivating a microbe capable of causing an infection in a subject.

A tenth aspect of the invention provides a method of inactivating a microbe capable of causing an infection in a subject, comprising using microfibrillated cellulose.

At least some of the aforementioned problems are addressed by spraying or applying coating compositions comprising nanocellulose. Optionally wherein the nanocellulose is microfibrillated cellulose (MFC). MFC comprising thin fibres that are a few hundred nanometers wide and several microns long, extracted from wood pulp or other cellulose containing pulps, onto textiles, may reduce the porosity of the textile significantly. There is currently no such product on the market.

It is notable that the present invention has no safety and toxicological implications, and can be reapplied to the textile based face masks after being washed as an ordinary garment. Most importantly, the nanocellulose (optionally wherein the nanocellulose is MFC) could be sourced from wood pulp, biowaste, and potentially end-of-life textiles or other cellulose containing materials or recycled cellulosic materials. This closes the loop for circular economy to best utilize the value of wastes such as textiles and packaging materials.

Advantages of the present invention include an increased sustainability: disposal face masks or PPE based on non-woven plastic is no longer required. Nanocellulose (optionally wherein the nanocellulose is MFC) produced from biomass, recycled cellulosic materials or end-of-life textiles can be applied onto ordinary textile to accomplish the same filtration effectiveness.

Teachings of the present disclosure also produce minimal environmental impact: plastic need not be released into the environment that will either accumulate as landfill or disintegrate to form microplastics.

In addition, there is benefit for manufacturing resilience where future disruption with the supply chain in providing PPE and face masks to the general public and medical professionals can be minimised.

An eleventh aspect of the invention provides an article comprising a porous substrate and having on said porous substrate a coating comprising at least about 20 wt %, preferably from 20 wt % to 99.5 wt % nanocellulose (optionally wherein the nanocellulose is microfibrillated cellulose) based on the total weight of the coating.

A twelfth aspect of the invention provides an article comprising a porous substrate and having on said porous substrate a coating comprising nanocellulose (optionally wherein the nanocellulose is microfibrillated cellulose).

A thirteenth aspect of the invention provides a method of applying a coating to a porous substrate, the method comprising:
(i) treating the porous substrate with a composition comprising a suspension of nanocellulose (optionally wherein the nanocellulose is microfibrillated cellulose) in a liquid component comprising water and optionally a water miscible component or water immiscible compound(s); and
(ii) obtaining a porous substrate coated with a coating comprising nanocellulose (optionally wherein the nanocellulose is microfibrillated cellulose).

A fourteenth aspect of the invention provides a composition comprising a suspension of nanocellulose (optionally wherein the nanocellulose is microfibrillated cellulose) in a liquid component comprising water and optionally a water miscible component or water immiscible compound(s).

A fifteenth aspect of the invention provides a method of applying a coating to a porous substrate, the method comprising (i) treating the porous substrate with a composition according to the fourteenth aspect of the invention; and (ii) obtaining a porous substrate coated with a coating comprising nanocellulose (optionally wherein the nanocellulose is microfibrillated cellulose).

A sixteenth aspect of the invention provides an article comprising a porous substrate coated with a coating applied according to the methods of the thirteenth or fifteenth aspects of the invention.

A seventeenth aspect of the invention provides an article comprising a porous substrate coated with the composition of the fourteenth aspect of the invention.

An eighteenth aspect of the invention provides the use of a composition according to the fourteenth aspect of the invention in a method of preparing a viral and microbial inactivation surface coating.

A nineteenth aspect of the invention provides the use of nanocellulose (optionally wherein the nanocellulose is microfibrillated cellulose) for inactivating a microbe capable of causing an infection in a subject.

A twentieth aspect of the invention provides a method of inactivating a microbe capable of causing an infection in a subject, comprising using nanocellulose (optionally wherein the nanocellulose is microfibrillated cellulose).

A further aspect of the invention provides an article comprising a porous substrate optionally selected from a woven or non-woven material, or a combination thereof, and having on said porous substrate a coating comprising at least about 20 wt %, preferably from 20 wt % to 99.5 wt % nanocellulose (optionally wherein the nanocellulose is microfibrillated cellulose) based on the total weight of the coating.

In an embodiment, the porous substrate is a woven textile fabric.

In another embodiment, the woven textile product is a medical textile product.

In a further embodiment, the medical textile product is a mask.

In an embodiment, the porous substrate is a non-woven material.

In another embodiment, the non-woven material is a medical non-woven material.

In a further embodiment, the medical non-woven material is a mask.

In an embodiment, the porous substrate is a combination of a woven and a non-woven material.

In another embodiment, the woven and non-woven material is a medical woven and non-woven material.

In a further embodiment, the medical woven and non-woven material is a mask.

A further aspect of the invention provides a method of applying a coating to a porous substrate, optionally selected from a woven or non-woven material, or a combination thereof, the method comprising: (i) treating the porous substrate with a composition comprising a suspension of nanocellulose (optionally wherein the nanocellulose is microfibrillated cellulose) in a liquid component comprising water and optionally a water miscible component or water immiscible compound(s); and (ii) obtaining a porous substrate coated with a coating comprising nanocellulose (optionally wherein the nanocellulose is microfibrillated cellulose).

In an embodiment, the composition is applied to the porous substrate by spray coating.

In an embodiment, the composition is applied to the porous substrate by drop casting.

In an embodiment, the composition is applied to the porous substrate by soaking.

In another embodiment, following the treatment of step (i), the composition is dried to form the coating by evaporation of the liquid component at room temperature.

In a further embodiment, the substrate to be treated comprises a porous substrate of a woven textile fabric and, in another embodiment, the woven textile fabric is a medical textile fabric, and, in another embodiment the medical textile fabric is a mask.

In another embodiment, the substrate to be treated comprises a porous substrate of a non-woven material, and in another embodiment the non-woven material is a medical non-woven material, and in a further embodiment the medical non-woven material is a mask.

In a still further embodiment, the porous substrate is a combination of a woven and a non-woven material, and in another embodiment the combination of a woven and a non-woven material is a medical woven and non-woven material, and in a further embodiment the medical woven and non-woven material is a mask.

In an embodiment of the foregoing method aspects of the invention, the composition comprises nanocellulose (optionally wherein the nanocellulose is microfibrillated cellulose) in an amount of about 0.1 to about 10 wt % based on the total weight of the composition, optionally wherein the composition comprises nanocellulose (optionally wherein the nanocellulose is microfibrillated cellulose) in an amount of about 0.1 to about 5 wt % based on the total weight of the composition.

In an embodiment of the foregoing method aspects of the invention, the composition comprises a water miscible component, optionally wherein the water miscible component is an alcohol.

In an embodiment of the foregoing method aspects of the invention, the composition comprises a water immiscible compound(s), optionally wherein the water immiscible compound(s) is an emulsion formed from oil/wax.

In an embodiment of the foregoing method aspects of the invention, the composition comprises an inorganic particulate material.

In an embodiment of the foregoing method aspects of the invention, the composition comprises particles of silver, copper, copper oxide, bismuth, cobalt, platinum or a mixture thereof.

In an embodiment of the foregoing method aspects of the invention, the composition comprises one or more carbon-based nanomaterials (CBNs).

In an embodiment of the foregoing method aspects of the invention, the one or more CBNs comprise one or more of fullerene, carbon dots, graphene, and derivatives thereof.

In an embodiment of the foregoing method aspects of the invention, the composition comprises a quaternary ammonium compound.

In an embodiment of the foregoing method aspects of the invention, the composition comprises one or more bio-based actives, optionally wherein the one or more bio-based actives comprise one or more of chitosan and carrageenan.

In an embodiment of the foregoing article and method aspects of the invention, the coating has an inactivating effect on a microbe capable of causing an infection in a subject.

In an embodiment of the foregoing article and method aspects of the invention, the coating has an inactivating effect on a virus capable of causing a viral infection in a subject, optionally wherein the virus is an RNA virus selected from the group consisting of a coronavirus (including a coronavirus selected from the group consisting of MERS-CoV, SARS-CoV, and SARS-CoV-2), an influenza virus, a rhinovirus, Measles virus and Mumps virus.

In an embodiment of the foregoing article and method aspects of the invention, the coating is obtained in the form of a film.

In an embodiment of the foregoing article and method aspects of the invention, the coating has a thickness of between about 50 and about 2000 nm.

In an embodiment of the foregoing article aspects of the invention, the article comprises a coating applied according to the method aspects of the invention.

An aspect of the invention provides a use of a composition comprising a suspension of nanocellulose (optionally wherein the nanocellulose is microfibrillated cellulose) in a liquid component comprising water, and optionally a water miscible component or water immiscible compound(s), in a method of preparing a viral and microbial inactivation surface coating.

An aspect of the invention provides a use of nanocellulose (optionally wherein the nanocellulose is microfibrillated cellulose) for inactivating a microbe capable of causing an infection in a subject.

An aspect of the invention provides a method of inactivating a microbe capable of causing an infection in a subject, comprising using nanocellulose (optionally wherein the nanocellulose is microfibrillated cellulose).

### BRIEF DESCRIPTION OF THE DRAWINGS

FIG. 1A is an optical microscopic image of an MFC thin film prepared by the herein described spin coating method.

FIG. 1B is an optical microscopic image of an MFC thin film prepared by the herein described spray coating method.

FIG. 1C is an atomic force microscopic image of an MFC thin film prepared by the herein described spin coating method.

FIG. 1D is an atomic force microscopic image of an MFC thin film prepared by the herein described spray coating method.

FIG. 1E is a scanning electron microscopic image of an MFC thin film prepared by the herein described spin coating method.

FIG. 1F is a scanning electron microscopic image of an MFC thin film prepared by the herein described spray coating method.

FIG. 2A shows the height distribution of MFC thin films prepared by the herein described spin coating method and spray coating method.

FIG. 2B shows uncoated glass (top), a spray coated MFC film (middle) and a spin coated MFC film (bottom) in natural light:

FIG. 3A shows the roughness and waviness of a series of spin coated MFC thin films prepared according to the herein described spin coating methods.

FIG. 3B shows the porosity and mean pore size of a series of spin coated MFC thin films prepared according to the herein described spin coating methods.

FIGS. 4A to 4F show optical microscopic images of the MFC thin films before and after the scraping tests of example 1.

FIG. 5A shows the contact angle of the water droplets of example 2.1.

FIG. 5B shows the disappearance time of the water droplets of example 2.1.

FIGS. 6 to 9 show the evaporation behavior of the droplets of examples 2.2.1 to 2.2.4, respectively.

FIG. 10 shows the redistribution of 1 mm diameter artificial saliva droplets according to examples 3.1, 3.2 and 3.3.

FIG. 11 shows the redistribution of 1 mm diameter artificial saliva droplets according to examples 3.4, 3.5 and 3.6.

FIG. 12 shows the redistribution of 1 mm diameter artificial saliva droplets according to examples 3.7, 3.8 and 3.9.

FIG. 13 shows the area of fluorescent stained mucin on the artificial skin following the touch tests in examples 3.1 to 3.6.

FIG. 14 shows the area of fluorescent stained mucin on the artificial skin following the touch tests in examples 3.7 to 3.12.

FIG. 15 shows the effect of the settlement time and surface specification on resultant infection with SARS-CoV-2 as described in example 4.1.

FIG. 16 shows the viability of E. coli after incubation on the MFC thin film and glass for 1 h and 24 h as described in example 4.2.

FIG. 17 shows the viability of S.epidermidis after incubation on the MFC thin film and glass for 1 h and 24 h as described in example 4.2.

FIG. 18 is an atomic force microscopy image of the MFC coating exposed to viral titre showing that the porous coating was able to capture individual virus as described in example 4.3.

FIG. 19 shows the contact angle of the water droplets of example 5.1.

FIG. 20 shows the disappearance time of the water droplets of example 5.1.

FIGS. 21 to 24 show the evaporation behavior of the droplets of examples 5.2.1 to 5.2.4, respectively.

FIG. 25 shows the effect of the settlement time and surface specification on resultant infection with SARS-CoV-2 as described in example 6.1.

FIG. 26 shows the viability of E. coli after incubation on the MFC thin film and glass for 1 h and 24 h as described in example 6.2.

FIG. 27 shows the viability of S. epidermidis after incubation on the MFC thin film and glass for 1 h and 24 h as described in example 6.2.

FIG. 28A shows a Scanning Electron Microscopy (SEM) image of a piece of cotton treated with a liquid composition comprising microfibrillated cellulose.

FIG. 28B shows a Scanning Electron Microscopy (SEM) image of a piece of polyester treated with a liquid composition of microfibrillated cellulose.

FIG. 29 is a schematic diagram of the measurement equipment used in Example 7.

### DETAILED DESCRIPTION OF THE INVENTION

Viral and Microbial Inactivation Effect

As used herein the term ‘antimicrobial surface coating’ is intended to mean that the external surface of a substrate on which coating according to the invention is applied is active against microbes so as to prevent or reduce the transmission of the microbes from the surface of said substrate. The term antimicrobial refers to the effect on bacteria, viruses and/or fungi. In some embodiments, the ‘antimicrobial surface coating’ is an ‘antiviral surface coating’. In some embodiments, the microbe is selected from the group consisting of bacteria, viruses and/or fungi. In some embodiments, the microbe is a virus.

As used herein the term ‘viral and microbial inactivation surface coating’ and like designations, is intended to mean that the external surface of a porous substrate on which a viral and microbial inactivation surface coating according to the invention is applied inactivates microbes, e.g. viruses, so as to prevent or reduce the transmission of the microbes or viruses from the surface of the porous substrate. The term viral and microbial inactivation effect refers to the effect on bacteria, viruses and/or fungi. In some embodiments, the ‘viral and microbial inactivation surface coating’ is an ‘antiviral surface coating’. In some embodiments, the microbe is selected from the group consisting of bacteria, viruses and/or fungi. In some embodiments, the microbe is a virus.

In some embodiments, the coating has an inactivating effect on a microbe capable of causing an infection in a subject. In some embodiments, the microbe is bacteria, optionally E. coli and/or S. epidermidis. In some embodiments, the subject is a human.

In some embodiments, the coating has an inactivating effect on a virus capable of causing a viral infection in a subject optionally a virus capable of causing an airborne viral infection in a subject. In some embodiments, the virus is an RNA virus. In some embodiments, the virus is an RNA virus selected from the group consisting of a coronavirus (including a coronavirus selected from MERS-CoV, SARS-CoV, and SARS-CoV-2), an influenza virus, a rhinovirus, Measles virus and Mumps virus. In some embodiments, the virus is a coronavirus. In some embodiments, the virus is SARS-CoV-2. In some embodiments, the subject is a human.

As used herein an ‘airborne viral infection’ is an infection transmitted by an airborne virus. An ‘airborne virus’ is a virus in which the disease spreads in particles in exhaled air (e.g., through respiratory droplets and their nuclei). These particles include respiratory droplets (>5-10 μm) and aerosols (≤5 μm) that include the virus. Transmission of an airborne viral infection can also take place through a subject touching fomite surfaces that have been contaminated by respiratory secretions or droplets expelled by an infected subject.

As used herein the term ‘inactivating effect on a microbe’ means that the coating improves microbe inactivation compared to a corresponding untreated surface or porous substrate. Such an improvement in microbe inactivation may include an improvement in the prevention or reduction of transmission of the microbe from the surface or porous substrate. Such an improvement may include an increase in the speed and/or extent of microbe inactivation. As used herein the corresponding untreated surface or porous substrate, refers to the same surface or porous substrate, or an equivalent surface or porous substrate, prior to the application of the coating. For example if the coated surface is glass, the corresponding untreated surface is the same type of glass without the coating such that a like-for-like comparison can be made. For example if the coated porous substrate is a textile, e.g., a cotton and/or polyester, the corresponding untreated substrate is the same type of textile without the coating such that a like-for-like comparison can be made.

As used herein the term ‘inactivating effect on a virus’ means that the coating improves viral inactivation compared to a corresponding untreated surface or porous substrate. Such an improvement in viral inactivation may include an improvement in the prevention or reduction of transmission of the virus from the surface or porous substrate. Such an improvement may include an increase in the speed and/or extent of viral inactivation. As used herein the corresponding untreated surface or porous substrate, refers to the same surface or porous substrate, or an equivalent surface or porous substrate, prior to the application of the coating. For example if the coated surface is glass, the corresponding untreated surface is the same type of glass without the coating such that a like-for-like comparison can be made. In some embodiments, the antiviral activity is determined according to ISO 21702:2019 (Measurement of antiviral activity on plastics and other non-porous surfaces). For example if the coated porous substrate is a textile, e.g., a cotton and/or polyester, the corresponding untreated substrate is the same type of textile without the coating such that a like-for-like comparison can be made.

Porous Materials

As used in this specification, “porous materials” comprise woven and non-woven textile products. A textile product may be a medical textile product or a non-medical textile product.

A textile product may be classified by the fibers incorporated therein. A textile product may comprise natural fibers and/or man-made (i.e., synthetic) fibers. Example natural fibers include, but are not limited to, cotton, wool, flax (i.e., linen), and silk. Example man-made fibers include, but are not limited to, polyester, nylon, and rayon.

Woven medical textiles may comprise commodity fibers such as cotton, polyester and nylon or may be specialty fibers. Cotton is used frequently in gowns, beddings, sheets, pillow cases, uniforms and surgical hosiery. Viscose is used in caps, masks and wipes. Polyester is also used in gowns, masks, and surgical coverings. Polyamide is typically used in surgical hosiery. Specialty fibers are generally specialty hair fibers from goats, alpacas and camels.

Non-woven materials are broadly defined as sheet or web structures bonded together by entangling fibers or filaments, or by perforating films, by mechanical, thermal or chemical means. Such non-woven materials may be flat, porous sheets made directly from separate fibers. In some cases the non-woven, porous material is made from molten plastic or plastic film. Non-woven materials are not made by weaving or knitting and do not require converting fibers to yarn.

Spunbond meltblown spunbond (SMS) medical textiles have excellent barrier properties and are particularly useful in preventing cross-infection between doctors and patients. SMS non-woven fabric products offer additional advantages in terms of cost. More recent variations include SMMS, SSMMS, etc. to form multilayer composite materials. Manufacturing processes for medical non-woven materials are various and well understood in the art. The most popular manufacturing process for medical non-wovens are spundbonding, meltblowing and the composite of both, for example, SMS, which is a trilaminate non-woven fabric made up of a top layer of spunbond polypropylene, a middle layer of meltblown polypropylene and a bottom layer of spunbond polypropylene.

Non-woven materials may be a limited-life, single-use fabric or a very durable fabric. Nonwoven fabrics provide specific functions such as absorbency, liquid repellency, resilience, stretch, softness, strength, flame retardancy, washability, cushioning, filtering, bacterial barriers and sterility. These properties are often combined to produce fabrics suited for specific jobs while achieving a good balance between product use-life and cost. They can mimic the appearance, texture and strength of a woven fabric, and can be as bulky as the thickest paddings. Many such materials possess special properties such as bacterial and viral barriers, sterility, filtering, absorbency, resilience, liquid repellency, stretch, softness, flame retardancy, cushioning and washability.

Medical textiles can be classified as natural and synthetic based products. Natural fibers may be derived from wood pulp, cotton and rayon. Wood pulp provides natural absorbency as well as bulk and low cost. Cotton and rayon may be used directly on wounds. Natural fibers are excellent in terms of absorbency (e.g., exudate and blood), breathability, launderability and their ability to be sterilized. Such natural fibers are biodegradable, which is an important feature. Natural fibers also possess excellent dimensional stability and heat stability, as well as water retention properties. Such natural fibers also are nonallergenic and nonirritant in nature. Non-woven cotton, alone or blended with other types of natural or synthetic fibers, is a non-woven frequently used as a medical textile alone or in combination of cotton with silk, chiffon, or flannel.

Synthetic fibers are widely used, principally as polypropylene fibers. They possess hydrophobicity, which is important in terms of barrier properties. Other synthetic fibers are polyesters, which possess good strength and mechanical properties and they may be sterilized readily. Further desirable properties include strength, solvent resistance, and static dissipation. They are also low cost and easy to produce and dispose of.

Medical textiles provide excellent barrier properties, superior efficiency and can be optimized for comfort, thickness, weight, water vapor transmission, air permeability, etc. Such medical textiles may also be optimized in terms of other physical properties such as tensile strength, tear resistance and abrasion resistance.

Non-woven polypropylene fabric may be used as a layer in a mask. An example is “spunbond” polypropylene which is used as a middle layer in washable cloth mask.

SARS-CoV-2 infection is transmitted predominately by inhalation of respiratory droplets generated when people cough, sneeze, sing, talk, or breathe. Health authorities worldwide, for example the CDC, recommends use of non-valved multilayer cloth masks to prevent the transmission of SARS-CoV-2. Non-valved masks do not have an open portal which may transmit a virus or bacterium. The face masks are employed to reduce the emission of virus-containing droplets. This is very relevant for asymptomatic or pre-symptomatic infected wearers. Mask also prevent or at least reduce inhalation of virus-laden droplets.

Multilayer cloth masks have been shown to block release of exhaled respiratory particles along with the microorganisms that such particles contain. Leung NHL, Chu DKW, Shiu EYC, et al. Respiratory virus shedding in exhaled breath and efficacy of face masks. Nature Medicine. Apr. 3 2020; 26(5):676-680. doi:https://dx.doi.org/10.1038/s41591-020-0843-2. Cloth masks have been shown to effectively block most large droplets of 20 to 30 microns and larger. Bandiera L., Pavar G., Pisetta G., et al. Face coverings and respiratory tract droplet dispersion. medRxiv. 2020; doi:10.1101/2020.08.11.2014508. They may also block exhalation of fine droplets and particles (aerosols) of 10 microns or less. Lindsley W G, Blachere F M, Law B F, Beezhold D H, Noti J D. Efficacy of face masks, neck gaiters and face shields for reducing the expulsion of simulated cough-generated aerosols. Aerosol Sci Technol. 2020. See Science Brief: Community Use of Cloth Masks to Control the Spread of SARS-CoV-2, CDC last updated May 7, 2021. https://www.cdc.gov/coronavirus/2019-ncov/science/science-briefs/masking-science-sars-cov2.html.

Other medical textile products include single use (or disposable) and durable clothing, protective clothing, garment linings, interlinings, waddings, shoe linings, point bonded non-woven nylon (breathable), filters, diapers, hygiene products, household and personal wipes and sterile medical-use products.

Coating Composition

In some embodiments, the composition comprises microfibrillated cellulose in an amount of about 0.1 to about 40 wt % based on the total weight of the composition. In some embodiments, the composition comprises microfibrillated cellulose in an amount of about 0.1 to about 30 wt % based on the total weight of the composition. In some embodiments, the composition comprises microfibrillated cellulose in an amount of about 0.1 to about 25 wt % based on the total weight of the composition. In some embodiments, the composition comprises microfibrillated cellulose in an amount of about 0.1 to about 20 wt % based on the total weight of the composition. In some embodiments, the composition comprises microfibrillated cellulose in an amount of about 0.1 to about 15 wt % based on the total weight of the composition. In some embodiments, the composition comprises microfibrillated cellulose in an amount of about 0.1 to about 10 wt % based on the total weight of the composition. In some embodiments, the composition comprises microfibrillated cellulose in an amount of about 0.1 to about 5 wt % based on the total weight of the composition. In some embodiments, the composition comprises microfibrillated cellulose in an amount of about 0.1 to about 4 wt % based on the total weight of the composition. In some embodiments, the composition comprises microfibrillated cellulose in an amount of about 0.1 to about 3 wt % based on the total weight of the composition. In some embodiment, the composition comprises microfibrillated cellulose in an amount of about 0.1 to about 2 wt % based on the total weight of the composition.

As used herein reference to the ‘total weight of the composition’ includes all components of the composition including the weight of all liquids present in the composition unless otherwise stated.

In some embodiments, the composition comprises a suspension of microfibrillated cellulose in a liquid component. In some embodiments, the liquid component comprises one or more liquids, for example two, three, four or five liquids. Preferably, the liquid component comprises two liquids or three liquids. In some embodiments, the liquid component comprises liquids selected from the group consisting of water, methanol, ethanol, 1-propanol, 2-propanol, dimethylsulfoxide, acetonitrile, acetone, tetrahydrofuran and mixtures thereof.

In some embodiments, the liquid component comprises water. In some embodiments, the liquid component comprises water and optionally one or more other liquids. In some embodiments, the liquid component comprises water and optionally one or more other liquids. In some embodiments, the liquid component comprises a liquid selected from the group consisting of methanol, ethanol, 1-propanol, 2-propanol, dimethylsulfoxide, acetonitrile, acetone, tetrahydrofuran and mixtures thereof. In some embodiments, the composition comprises a suspension of microfibrillated cellulose in a liquid comprising water and one or more other liquids optionally selected from the group consisting of methanol, ethanol, 1-propanol, 2-propanol, dimethylsulfoxide, acetonitrile, acetone, tetrahydrofuran and mixtures thereof.

In some embodiments, the composition comprises a suspension of microfibrillated cellulose in a liquid component comprising water and one or more polar liquids. In some embodiments, the composition comprises a suspension of microfibrillated cellulose in a liquid comprising water and one or more alcohols optionally selected from the group consisting of methanol, ethanol, 1-propanol, 2-propanol and mixtures thereof. In some embodiments, the composition comprises a suspension of microfibrillated cellulose in a liquid component comprising water and ethanol.

In some embodiments, the composition comprises a suspension of microfibrillated cellulose in a liquid component comprising water and optionally one or more other liquids, wherein the ratio of water:other liquids is from about 1:1 to about 1:10 (v:v), optionally from about 1:3 to about 1:7 (v:v). In some embodiments, the composition comprises a suspension of microfibrillated cellulose in a liquid component comprising water and one or more alcohols (optionally selected from the group consisting of methanol, ethanol, 1-propanol, 2-propanol and mixtures thereof), wherein the ratio of water:alcohols is from about 1:1 to about 1:10 (v:v), optionally from about 1:3 to about 1:7 (v:v). In some embodiments, the alcohol is selected from the group consisting of methanol, ethanol, 1-propanol, 2-propanol and mixtures thereof.

In some embodiments, the microfibrillated cellulose content of the composition is in the range of from about 0.01 to about 99.9 wt % based on the weight of solids in the composition. In some embodiment, the microfibrillated cellulose content of the composition is in the range of about 70 to about 99 wt %, in the range of about 80 to about 99 wt %, or in the range of from about 90 to about 99 wt % of the solids in the composition.

In some embodiments, the composition is sprayable.

In some embodiments, the composition comprises nanocellulose (optionally wherein the nanocellulose is microfibrillated cellulose) in an amount of about 0.1 to about 40 wt % based on the total weight of the composition. In some embodiments, the composition comprises nanocellulose (optionally wherein the nanocellulose is microfibrillated cellulose) in an amount of about 0.1 to about 35 wt % based on the total weight of the composition. In some embodiments, the composition comprises nanocellulose (optionally wherein the nanocellulose is microfibrillated cellulose) in an amount of about 0.1 to about 30 wt % based on the total weight of the composition. In some embodiments, the composition comprises nanocellulose (optionally wherein the nanocellulose is microfibrillated cellulose) in an amount of about 0.1 to about 25 wt % based on the total weight of the composition. In some embodiments, the composition comprises nanocellulose (optionally wherein the nanocellulose is microfibrillated cellulose) in an amount of about 0.1 to about 20 wt % based on the total weight of the composition. In some embodiments, the composition comprises nanocellulose (optionally wherein the nanocellulose is microfibrillated cellulose) in an amount of about 0.1 to about 15 wt % based on the total weight of the composition. In some embodiments, the composition comprises nanocellulose (optionally wherein the nanocellulose is microfibrillated cellulose) in an amount of about 0.1 to about 10 wt % based on the total weight of the composition. In some embodiments, the composition comprises nanocellulose (optionally wherein the nanocellulose is microfibrillated cellulose) in an amount of about 0.1 to about 5 wt % based on the total weight of the composition. In some embodiments, the composition comprises nanocellulose (optionally wherein the nanocellulose is microfibrillated cellulose) in an amount of about 0.1 to about 4 wt % based on the total weight of the composition. In some embodiments, the composition comprises nanocellulose (optionally wherein the nanocellulose is microfibrillated cellulose) in an amount of about 0.1 to about 3 wt % based on the total weight of the composition. In some embodiment, the composition comprises nanocellulose (optionally wherein the nanocellulose is microfibrillated cellulose) in an amount of about 0.1 to about 2 wt % based on the total weight of the composition. In some embodiment, the composition comprises nanocellulose (optionally wherein the nanocellulose is microfibrillated cellulose) in an amount of about 0.1 to about 1 wt % based on the total weight of the composition.

As used herein reference to the ‘total weight of the composition’ includes all components of the composition including the weight of all liquids present in the composition unless otherwise stated.

In some embodiments, the composition comprises a suspension of nanocellulose (optionally wherein the nanocellulose is microfibrillated cellulose) in a liquid component. In some embodiments, the liquid component comprises one or more liquids, for example two, three, four or five liquids. Preferably, the liquid component comprises two liquids or three liquids. In some embodiments, the liquid component comprises one or more liquids selected from the group consisting of water, methanol, ethanol, 1-propanol, 2-propanol, dimethylsulfoxide, acetonitrile, acetone, tetrahydrofuran and mixtures thereof.

In some embodiments, the liquid component comprises water. In some embodiments, the liquid component comprises water and optionally one or more other liquids. In some embodiments, the composition comprises a suspension of microfibrillated cellulose in a liquid comprising water and one or more other liquids optionally selected from the group consisting of methanol, ethanol, 1-propanol, 2-propanol, dimethylsulfoxide, acetonitrile, acetone, tetrahydrofuran and mixtures thereof.

In some embodiments, the composition comprises a suspension of nanocellulose (optionally wherein the nanocellulose is microfibrillated cellulose) in a liquid component comprising water and one or more polar liquids. In some embodiments, the composition comprises a suspension of nanocellulose (optionally wherein the nanocellulose is microfibrillated cellulose) in a liquid comprising water and one or more alcohols optionally selected from the group consisting of methanol, ethanol, 1-propanol, 2-propanol and mixtures thereof. In some embodiments, the composition comprises a suspension of nanocellulose (optionally wherein the nanocellulose is microfibrillated cellulose) in a liquid component comprising water and ethanol.

In some embodiments, the composition comprises a suspension of nanocellulose (optionally wherein the nanocellulose is microfibrillated cellulose) in a liquid component comprising water and optionally one or more other liquids, wherein the ratio of water:other liquids is from about 1:1 to about 1:10 (v:v), optionally from about 1:3 to about 1:7 (v:v). In some embodiments, the composition comprises a suspension of nanocellulose (optionally wherein the nanocellulose is microfibrillated cellulose) in a liquid component comprising water and one or more alcohols (optionally selected from the group consisting of methanol, ethanol, 1-propanol, 2-propanol and mixtures thereof), wherein the ratio of water:alcohols is from about 1:1 to about 1:10 (v:v), optionally from about 1:3 to about 1:7 (v:v). In some embodiments, the alcohol is selected from the group consisting of methanol, ethanol, 1-propanol, 2-propanol and mixtures thereof.

In some embodiments, the composition comprises a suspension of nanocellulose (optionally wherein the nanocellulose is microfibrillated cellulose) in a liquid component comprising one or more nonpolar components. In some embodiments, the composition comprises a suspension of nanocellulose (optionally wherein the nanocellulose is microfibrillated cellulose) in a liquid comprising an emulsion. In some embodiments, the emulsion can comprise one or more hydrophobic agents (e.g., fatty acid), one or more surfactants, and combinations thereof.

The emulsion can comprise, consist essentially of, or consist of one or hydrophobic agents, one or more surfactants, and combinations thereof. In some embodiments, the emulsion comprises, consists essentially of, or consists of one surfactant and a hydrophobic agent. In embodiments where the emulsion “consists essentially of” the one or more hydrophobic components, one or more surfactants, and combinations thereof, the emulsion does not comprise, or is free of, any components that would deleteriously effect the emulsion (e.g., disrupt the ability of the emulsion to form emulsion droplets and/or other types of agglomerations). For example, emulsions that “consist essentially of” the one or more hydrophobic components, one or more surfactants, and combinations thereof are free of components that would result in creaming, sedimentation, flocculation, coalescence, or separation of the emulsion. In embodiments where the emulsion comprises a fatty acid and a surfactant, the surfactant may be selected based on its ability to form hydrophobic droplets (or other type of agglomerated structure).

In some embodiments, the one or more hydrophobic components of the emulsion may be an oil or a fatty acid. The oil may be an essential oil such as, but not limited to, thyme oil, clove oil, oregano oil, lemongrass oil, marjoram oil, cinnamon oil, coriander oil, vegetable oil, olive oil, avocado oil, coconut oil, and combinations thereof. In some embodiments, the fatty acid is a medium-chain fatty acid, with an aliphatic tail comprising 6 to 12 carbons (saturated or unsaturated), such as capric acid and lauric acid. In some embodiments, the fatty acid is a long-chain fatty acid, with an aliphatic tail comprising of 13 to 21 carbons (saturated or unsaturated), such as oleic acid, linoleic acid, α-Linolenic acid, palmitic acid, stearic acid, arachidic acid, and combinations thereof.

In some embodiments, the one or more surfactants of the emulsion may be selected from a polysorbate surfactant (e.g., polyoxyethylene (20) sorbitan monolaurate, also referred to as ‘TWEEN 20”; or polyoxyethylene (80) sorbitan monolaurate, also referred to as “Tween 80”), a sorbitan surfactant (e.g., sorbitan monolaurate, also referred to as “SPAN 20”; or sorbitan monooleate, also referred to as “SPAN 80”), a sucrose ester of a fatty acid (e.g., a sucrose ester of a fatty acid having one to eight carbons in the hydrocarbon chain of the fatty acid, such as a sucrose ester of propionic acid, butyric acid, valeric acid, caprylic acid, or unsaturated versions thereof), or any combinations thereof.

In some embodiments, the nanocellulose (optionally wherein the nanocellulose is microfibrillated cellulose) content of the composition is in the range of from about 0.01 to about 99.9 wt % based on the weight of solids in the composition. In some embodiment, the nanocellulose (optionally wherein the nanocellulose is microfibrillated cellulose) content of the composition is in the range of from about 70 to about 99 wt %, in the range of about 80 to about 99 wt %, or in the range of from about 90 to about 99 wt % of the solids in the composition.

In some embodiments, the composition is sprayable.

In some embodiments less than 5 mL of a nanocellulose (optionally wherein the nanocellulose is microfibrillated cellulose) liquid composition formulated at 1 wt % may be sufficient to treat a single face mask. Thus, as little as 0.05 g nanocellulose (optionally wherein the nanocellulose is microfibrillated cellulose) is required per treatment of each mask.

Nanocellulose

In some embodiments, a coating of the present disclosure may include nanocellulose. As used herein, “nanocellulose” refers to cellulose structures with one dimension (e.g., diameter) in the sub-micron region (i.e., <1 μm).

In some embodiments, the nanocellulose is microfibrillated cellulose (MFC).

Nanocellulose may include cellulose nanofiber (CNF). CNF refers to cellulose structures have a diameter of about 5 nm to about 10 nm, and an average length of about 50 nm to about 100 nm. To product CNF, wood may be crushed into woodchips of about 5 cm in width and 1 cm in thickness. At a paper mill, fibers are extracted from the woodchips and pulped. The pulp is then chemically processed to product thin pieces, followed by application of high pressure to loosen the wood fibers, producing CNF.

Nanocellulose may include nanofibrillated cellulose (NFC). NFC refers to cellulose fibers that have been fibrillated (via mechanical disintegration) to achieve agglomerates of cellulose microfibril units. NFC has nanoscale (e.g., <100 nm) diameter, and a typical length of several micrometers. NFC may be product from various cellulosic sources including, but not limited to, wood, bleached kraft pulp, bleached sulfite pulp, sugar beet pulp, wheat straw and soy hulls, sisal, bagasse, palm trees, ramie, carrots, and luffa cylindrical. NFC may be produced using various mechanical disintegration processes and systems such as, but not limited to, a homogenizer system, a microfluidizer, and a grinder.

Nanocellulose may include microfibrillated cellulose (MFC), as described herein below.

Nanocellulose may include cellulose nanocrystals (CNCs). CNCs are a derivative of cellulose, which can be obtained through acid hydrolysis of cellulose, where the cellulose is exposed to (e.g., sulfuric) acid under controlled temperature for a time period. CNCs can be isolated from various renewable resources such as plants (e.g., cotton and wood), bacteria, and sea animals. Depending on the isolation method utilized and the source of the cellulose, CNCs can range from 5 nm to 30 nm in diameter, and have aspect ratios up to about 100. CNCs can have high specific strength and Young's modulus. Moreover, the active hydroxyl surface groups of CNCs enable chemical functionalization.

Microfibrillated Cellulose

The microfibrillated cellulose used in the coating according to the present invention can be prepared using methods known in the art.

Microfibrillated cellulose (MFC) shall in the context of the patent application mean a nanoscale cellulose particle fiber or fibril with at least one dimension less than about 100 nm. MFC comprises partly or totally fibrillated cellulose or lignocellulose fibers. The liberated fibrils have a diameter less than about 100 nm, whereas the actual fibril diameter or particle size distribution and/or aspect ratio (length/width) depends on the source and the manufacturing methods.

The smallest fibril is called elementary fibril and has a diameter of approximately 2-4 nm (see e.g. Chinga-Carrasco, G., Cellulose fibres, nanofibrils and microfibrils: The morphological sequence of MFC components from a plant physiology and fibre technology point of view, Nanoscale Research Letters 2011, 6:417), while it is common that the aggregated form of the elementary fibrils, also defined as microfibril (Fengel, D., Ultrastructural behavior of cell wall polysaccharides, Tappi J., March 1970, Vol 53, No. 3.), is the main product that is obtained when making MFC e.g. by using an extended refining process or pressure-drop disintegration process. Depending on the source and the manufacturing process, the length of the fibrils can vary from around 1 to more than 10 micrometers. A coarse MFC grade might contain a substantial fraction of fibrillated fibers, i.e. protruding fibrils from the tracheid (cellulose fiber), and with a certain amount of fibrils liberated from the tracheid (cellulose fiber).

There are different acronyms for MFC such as cellulose microfibrils, fibrillated cellulose, nanofibrillated cellulose, fibril aggregates, nanoscale cellulose fibrils, cellulose nanofibers, cellulose nanofibrils, cellulose microfibers, cellulose fibrils, microfibrillar cellulose, microfibril aggregates and cellulose microfibril aggregates. MFC can also be characterized by various physico-chemical properties such as large surface area or its ability to form a gel-like material at low solid contents (1-5 wt %) when dispersed in water. The cellulose fiber is preferably fibrillated to such an extent that the final specific surface area of the formed MFC is from about 1 to about 300 m²/g, such as from about 1 to about 200 m²/g or more preferably about 50-200 m²/g when determined for a freeze-dried material with the BET method.

The nanofibrillar cellulose may contain some hemicelluloses, of which; the amount is dependent on the plant source. Mechanical disintegration of the pre-treated fibers, e.g. hydrolysed, pre-swelled, or oxidized cellulose raw material is carried out with suitable equipment such as a refiner, grinder, homogenizer, colloider, friction grinder, ultrasound sonicator, fluidizer such as microfluidizer, macrofluidizer or fluidizer-type homogenizer. Depending on the MFC manufacturing method, the product might also contain fines, or nanocrystalline cellulose or other chemicals present in wood fibers or in papermaking process. The product might also contain various amounts of micron size fiber particles that have not been efficiently fibrillated. MFC is produced from wood cellulose fibers, both from hardwood or softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper.

In some embodiments, the microfibrillated cellulose has a Schopper Riegler value (SR.degree.) of more than about 85 SR.degree., or more than about 90 SR.degree., or more than about 92 SR.degree. The Schopper-Riegler value can be determined through the standard method defined in EN ISO 5267-1.

The microfibrillated cellulose preferably has a water retention value of at least about 200%, more preferably at least about 250%, most preferably at least about 300%. The addition of certain chemicals may influence the water retention value.

The above described definition of MFC includes, but is not limited to, the new proposed TAPPI standard W13021 on cellulose nanofibril (CNF) defining a cellulose nanofiber material containing multiple elementary fibrils with both crystalline and amorphous region.

In some embodiments, the microfibrillated cellulose is obtained from a chemical pulp, or a chemithermomechanical pulp, or a mechanical pulp, or thermomechanical pulp, including, for example, Northern Bleached Softwood Kraft pulp (“NB SK”), Bleached Chemi-Thermo Mechanical Pulp (“BCTMP”), or a recycled pulp, or a paper broke pulp, or a papermill waste stream, or waste from a papermill, or combinations thereof.

In some embodiments, the pulp source is kraft pulp, or bleached long fibre kraft pulp.

In some embodiments, the pulp source is softwood pulp selected from spruce, pine, fir, larch and hemlock or mixed softwood pulp.

In some embodiments, the pulp source is hardwood pulp selected from eucalyptus, aspen and birch, or mixed hardwood pulps.

In some embodiments, the pulp source is eucalyptus pulp, spruce pulp, pine pulp, beech pulp, hemp pulp, acacia cotton pulp, and mixtures thereof.

In some embodiments, a fibrous substrate comprising cellulose has a Canadian Standard Freeness equal to or less than about 450 cm³.

In some embodiments, the invention relates to modifications, for example, improvements, to the methods and compositions described in WO-A-2010/131016, the entire contents of which are hereby incorporated by reference.

WO-A-2010/131016 discloses a process for preparing microfibrillated cellulose comprising microfibrillating, e.g., by grinding, a fibrous material comprising cellulose, optionally in the presence of grinding medium and inorganic particulate material. When used as a filler in paper, for example, as a replacement or partial replacement for a conventional mineral filler, the microfibrillated cellulose obtained by said process, optionally in combination with inorganic particulate material improved the burst strength properties of the paper. That is, relative to a paper filled with exclusively mineral filler, paper filled with the microfibrillated cellulose was found to have improved burst strength. In other words, the microfibrillated cellulose filler was found to have paper burst strength enhancing attributes. In one particularly advantageous embodiment of that invention, the fibrous material comprising cellulose was ground in the presence of a grinding medium, optionally in combination with inorganic particulate material, to obtain microfibrillated cellulose having a fibre steepness of from about 20 to about 50.

The method described in WO-A-2010/131016 comprises a step of microfibrillating a fibrous substrate comprising cellulose by grinding in the presence of a particulate grinding medium which is to be removed after the completion of grinding. By “microfibrillating” is meant a process in which microfibrils of cellulose are liberated or partially liberated as individual species or as small aggregates as compared to the fibres of the pre-microfibrillated pulp. Typical cellulose fibres (i.e., pre-microfibrillated pulp) suitable for use in papermaking include large aggregates of hundreds or thousands of individual cellulose fibrils. By microfibrillating the cellulose, particular characteristics and properties, including the characteristics and properties described herein, are imparted to the microfibrillated cellulose and the compositions comprising the microfibrillated cellulose.

The fibrous substrate comprising cellulose (variously referred to herein as “fibrous substrate comprising cellulose,” “cellulose fibres,” “fibrous cellulose feedstock,” “cellulose feedstock” and “cellulose-containing fibres (or fibrous,” etc.) may be derived from recycled pulp or a papermill broke and/or industrial waste, or a paper stream rich in mineral fillers and cellulosic materials from a papermill.

The recycled cellulose pulp may be beaten (for example in a Valley beater) and/or otherwise refined (for example, processing in a conical or plate refiner) to any predetermined freeness, reported in the art as Canadian standard freeness (CSF) in cm³. CSF means a value for the freeness or drainage rate of pulp measured by the rate that a suspension of pulp may be drained, and this test is carried out according to the T 227 cm-09 TAPPI standard. For example, the cellulose pulp may have a Canadian standard freeness of about 10 cm³ or greater prior to being microfibrillated. The recycled cellulose pulp may have a CSF of about 700 cm³ or less, for example, equal to or less than about 650 cm³, or equal to or less than about 600 cm³, or equal to or less than about 550 cm³, or equal to or less than about 500 cm³, or equal to or less than about 450 cm³, or equal to or less than about 400 cm³, or equal to or less than about 350 cm³, or equal to or less than about 300 cm³, or equal to or less than about 250 cm³, or equal to or less than about 200 cm³, or equal to or less than about 150 cm³, or equal to or less than about 100 cm³, or equal to or less than about 50 cm³. The recycled cellulose pulp may have a CSF of about 20 to about 700. The recycled cellulose pulp may then be dewatered by methods well known in the art, for example, the pulp may be filtered through a screen in order to obtain a wet sheet comprising at least about 10% solids, for example at least about 15% solids, or at least about 20% solids, or at least about 30% solids, or at least about 40% solids. The recycled pulp may be utilized in an unrefined state, that is to say without being beaten or dewatered, or otherwise refined.

In some embodiments, the microfibrillated cellulose may also be prepared from recycled pulp or a papermill broke and/or industrial waste, or a paper stream rich in mineral fillers and cellulosic materials from a papermill.

The fibrous substrate comprising cellulose may be added to a grinding vessel fibrous substrate comprising cellulose in a dry state. For example, a dry paper broke may be added directly to the grinder vessel. The aqueous environment in the grinder vessel will then facilitate the formation of a pulp.

The inorganic particulate material, when present, may, for example, be an alkaline earth metal carbonate or sulphate, such as calcium carbonate, magnesium carbonate, dolomite, gypsum, a hydrous kandite day such as kaolin, halloysite or ball clay, an anhydrous (calcined) kandite clay such as metakaolin or fully calcined kaolin, talc, mica, perlite or diatomaceous earth, or magnesium hydroxide, or aluminum trihydrate, or combinations thereof.

A preferred inorganic particulate material for use is calcium carbonate. Hereafter, the invention may tend to be discussed in terms of calcium carbonate, and in relation to aspects where the calcium carbonate is processed and/or treated. The invention should not be construed as being limited to such embodiments.

The particulate calcium carbonate optionally used in the present invention may be obtained from a natural source by grinding. Ground calcium carbonate (GCC) is typically obtained by crushing and then grinding a mineral source such as chalk, marble or limestone, which may be followed by a particle size classification step, in order to obtain a product having the desired degree of fineness. Other techniques such as bleaching, flotation and magnetic separation may also be used to obtain a product having the desired degree of fineness and/or color. The particulate solid material may be ground autogenously, i.e. by attrition between the particles of the solid material themselves, or, alternatively, in the presence of a particulate grinding medium comprising particles of a different material from the calcium carbonate to be ground. These processes may be carried out with or without the presence of a dispersant and biocides, which may be added at any stage of the process.

Precipitated calcium carbonate (PCC) may be used as the source of particulate calcium carbonate in the present invention, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in the practice of the present invention. In all three processes, a calcium carbonate feed material, such as limestone, is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process the milk of lime is contacted with soda ash to produce, by double decomposition, a precipitate of calcium carbonate and a solution of sodium hydroxide. The sodium hydroxide may be substantially completely separated from the calcium carbonate if this process is used commercially. In the third main commercial process, the milk of lime is first contacted with ammonium chloride to give a calcium chloride solution and ammonia gas. The calcium chloride solution is then contacted with soda ash to produce by double decomposition precipitated calcium carbonate and a solution of sodium chloride. The crystals can be produced in a variety of different shapes and sizes, depending on the specific reaction process that is used. The three main forms of PCC crystals are aragonite, rhombohedral and scalenohedral, all of which are suitable for use in the present invention, including mixtures thereof.

Wet grinding of calcium carbonate involves the formation of an aqueous suspension of the calcium carbonate which may then be ground, optionally in the presence of a suitable dispersing agent. Reference may be made to, for example, EP-A-614948 (the contents of which are incorporated by reference in their entirety) for more information regarding the wet grinding of calcium carbonate.

In some circumstances, minor additions of other minerals may be included, for example, one or more of kaolin, calcined kaolin, wollastonite, bauxite, talc or mica, could also be present.

When the inorganic particulate material is obtained from naturally occurring sources, it may be that some mineral impurities will contaminate the ground material. For example, naturally occurring calcium carbonate can be present in association with other minerals. Thus, in some embodiments, the inorganic particulate material includes some extent of impurities. In general, however, the inorganic particulate material used in the invention will contain less than about 5% by weight, preferably less than about 1% by weight, of other mineral impurities.

The inorganic particulate material which may be used during a microfibrillating step will preferably have a particle size distribution in which at least about 10% by weight of the particles have an equivalent spherical diameter (e.s.d.) of less than 2 μm, for example, at least about 20% by weight, or at least about 30% by weight, or at least about 40% by weight, or at least about 50% by weight, or at least about 60% by weight, or at least about 70% by weight, or at least about 80% by weight, or at least about 90% by weight, or at least about 95% by weight, or about 100% of the particles have an e.s.d of less than 2 μm.

Unless otherwise stated, particle size properties referred to herein for the inorganic particulate materials are as measured in a well-known manner by sedimentation of the particulate material in a fully dispersed condition in an aqueous medium using a Sedigraph 5100 machine as supplied by Micromeritics Instruments Corporation, Norcross, Ga., USA (telephone: +1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values. The mean particle size d₅₀ is the value determined in this way of the particle e.s.d at which there are 50% by weight of the particles which have an equivalent spherical diameter less than that d₅₀ value.

Alternatively, where stated, the particle size properties referred to herein for the inorganic particulate materials are as measured by the well-known conventional method employed in the art of laser light scattering, using a Malvern Mastersizer S machine as supplied by Malvern Instruments Ltd (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the ‘equivalent spherical diameter’ (e.s.d), less than given e.s.d values. The mean particle size d₅₀ is the value determined in this way of the particle e.s.d at which there are 50% by volume of the particles which have an equivalent spherical diameter less than that d₅₀ value.

Unless otherwise stated, particle size properties of the microfibrillated cellulose materials are measured by the well-known conventional method employed in the art of laser light scattering, using a Malvern Insitec L machine as supplied by Malvern Instruments Ltd (or by other methods which give essentially the same result).

Unless otherwise stated, particle size properties of the microfibrillated cellulose materials are measured by the well-known conventional method employed in the art of laser light scattering, using a Malvern Mastersizer S machine as supplied by Malvern Instruments Ltd (or by other methods which give essentially the same result).

The fibrous substrate comprising cellulose may be microfibrillated in the presence of an inorganic particulate material to obtain microfibrillated cellulose having a d₅₀ ranging from about 5 μm to about 500 μm, as measured by laser light scattering. The fibrous substrate comprising cellulose may be microfibrillated in the presence of an inorganic particulate material to obtain microfibrillated cellulose having a d₅₀ of equal to or less than about 400 μm, for example equal to or less than about 300 μm, or equal to or less than about 200 μm, or equal to or less than about 150 μm, or equal to or less than about 125 μm, or equal to or less than about 100 μm, or equal to or less than about 90 μm, or equal to or less than about 80 μm, or equal to or less than about 70 μm, or equal to or less than about 60 μm, or equal to or less than about 50 μm, or equal to or less than about 40 μm, or equal to or less than about 30 μm, or equal to or less than about 20 μm, or equal to or less than about 10 μm.

The fibrous substrate comprising cellulose may be microfibrillated in the presence of an inorganic particulate material to obtain microfibrillated cellulose having a modal fibre particle size ranging from about 0.1-500 μm and a modal inorganic particulate material particle size ranging from about 0.25-20 μm. The fibrous substrate comprising cellulose may be microfibrillated in the presence of an inorganic particulate material to obtain microfibrillated cellulose having a modal fibre particle size of at least about 0.5 μm, for example at least about 10 μm, or at least about 50 μm, or at least about 100 μm, or at least about 150 μm, or at least about 200 μm, or at least about 300 μm, or at least about 400 μm.

The fibrous substrate comprising cellulose may be microfibrillated in the presence of an inorganic particulate material to obtain microfibrillated cellulose having a fibre steepness equal to or greater than about 10, as measured by Malvern. Fibre steepness i.e., the steepness of the particle size distribution of the fibres) is determined by the following formula:

Steepness=100×(d_{30/d70})

The microfibrillated cellulose may have a fibre steepness equal to or less than about 100. The microfibrillated cellulose may have a fibre steepness equal to or less than about 75, or equal to or less than about 50, or equal to or less than about 40, or equal to or less than about 30. The microfibrillated cellulose may have a fibre steepness from about 20 to about 50, or from about 25 to about 40, or from about 25 to about 35, or from about 30 to about 40.

The finer mineral peak can be fitted to the measured data points and subtracted mathematically from the distribution to leave the fibre peak, which can be converted to a cumulative distribution. Similarly, the fibre peak can be subtracted mathematically from the original distribution to leave the mineral peak, which can also be converted to a cumulative distribution. Both these cumulative curves may then be used to calculate the mean particle size (d₅₀) and the steepness of the distribution (d₃₀/d₇₀×100). The differential curve may then be used to find the modal particle size for both the mineral and fibre fraction

Another preferred inorganic particulate material for use is kaolin clay. The invention should not be construed as being limited to such embodiments. Thus, in some embodiments, kaolin is used in an unprocessed form.

Kaolin clay used in this invention may be a processed material derived from a natural source, namely raw natural kaolin clay mineral. The processed kaolin clay may typically contain at least about 50% by weight kaolinite. For example, most commercially processed kaolin clays contain greater than about 75% by weight kaolinite and may contain greater than about 90%, in some cases greater than about 95% by weight of kaolinite.

Kaolin clay used in the present invention may be prepared from the raw natural kaolin clay mineral by one or more other processes which are well known to those skilled in the art, for example by known refining or beneficiation steps.

For example, the clay mineral may be bleached with a reductive bleaching agent, such as sodium hydrosulfite. If sodium hydrosulfite is used, the bleached clay mineral may optionally be dewatered, and optionally washed and again optionally dewatered, after the sodium hydrosulfite bleaching step.

The clay mineral may be treated to remove impurities, e.g. by flocculation, flotation, or magnetic separation techniques well known in the art. Alternatively the clay mineral used in the invention may be untreated in the form of a solid or as an aqueous suspension.

The process for preparing the particulate kaolin clay for use in the present invention may also include one or more comminution steps, e.g., grinding or milling. Light comminution of a coarse kaolin is used to give suitable delamination thereof. The comminution may be carried out by use of beads or granules of a plastic (e.g. nylon), sand or ceramic grinding or milling aid. The coarse kaolin may be refined to remove impurities and improve physical properties using well known procedures. The kaolin clay may be treated by a known particle size classification procedure, e.g., screening and centrifuging (or both), to obtain particles having a desired d₅₀ value or particle size distribution.

Manufacturing Microfibrillated Cellulose

Prior art methods of manufacturing microfibrillated cellulose include mechanical disintegration by refining, milling, beating and homogenizing, and refining, for example, by an extruder. These mechanical measures may be enhanced by chemical or chemo-enzymatic treatments as a preliminary step. Various known methods of microfibrillation of cellulosic fibres are summarized in U.S. Pat. No. 6,602,994 B1 as including e.g. homogenization, steam explosion, pressurization-depressurization, impact, grinding, ultrasound, microwave explosion, milling and combinations of these. WO 2007/001229 discloses enzyme treatment and, as a method of choice, oxidation in the presence of a transition metal for turning cellulosic fibres to MFC. After the oxidation step the material is disintegrated by mechanical means. A combination of mechanical and chemical treatment can also be used. Examples of chemicals that can be used are those that either modify the cellulose fibers through a chemical reaction or those that modify the cellulose fibers via e.g. grafting or sorption of chemicals onto/into the fibers.

Various methods of producing microfibrillated cellulose (“MFC”) are known in the art. Certain methods and compositions comprising microfibrillated cellulose produced by grinding procedures are described in WO-A-2010/131016. Husband, J. C., Svending, P., Skuse, D. R., Motsi, T., Likitalo, M., Coles, A., FiberLean Technologies Ltd., 2015, “Paper filler composition,” PCT International Application No. WO-A-2010/131016. Paper products comprising such microfibrillated cellulose have been shown to exhibit excellent paper properties, such as paper burst and tensile strength. The methods described in WO-A-2010/131016 also enable the production of microfibrillated cellulose economically.

WO 2007/091942 A1 describes a process, in which chemical pulp is first refined, then treated with one or more wood degrading enzymes, and finally homogenized to produce MFC as the final product. The consistency of the pulp is described to be preferably from about 0.4 to about 10%. The advantage is said to be avoidance of clogging in the high-pressure fluidizer or homogenizer.

WO2010/131016 describes a grinding procedure for the production of microfibrillated cellulose with or without inorganic particulate material. Such a grinding procedure is described below. In an embodiment of the process set forth in WO-A-2010/131016, the contents of which is hereby incorporated by reference in its entirety, the process utilizes mechanical disintegration of cellulose fibres to produce microfibrillated cellulose (“MFC”) cost-effectively and at large scale, without requiring cellulose pre-treatment. An embodiment of the method uses stirred media detritor grinding technology, which disintegrates fibres into MFC by agitating grinding media beads. In this process, a mineral such as calcium carbonate or kaolin is added as a grinding aid, greatly reducing the energy required. Husband, J. C., Svending, P., Skuse, D. R., Motsi, T., Likitalo, M., Coles, A., FiberLean Technologies Ltd., 2015, “Paper filler composition,” U.S. Pat. No. 9,127,405B2.

A stirred media mill consists of a rotating impeller that transfers kinetic energy to small grinding media beads, which grind down the charge via a combination of shear, compressive, and impact forces. A variety of grinding apparatus may be used to produce MFC by the disclosed methods herein, including, for example, a tower mill, a screened grinding mill, or a stirred media detritor.

Homogenization Preparation of Microfibrillated Cellulose

In some embodiments, microfibrillation of a fibrous substrate comprising cellulose may be effected under wet conditions in the presence of the inorganic particulate material by a method in which the mixture of cellulose pulp and inorganic particulate material is pressurized (for example, to a pressure of about 500 bar) and then passed to a zone of lower pressure. The rate at which the mixture is passed to the low-pressure zone is sufficiently high and the pressure of the low pressure zone is sufficiently low to cause microfibrillation of the cellulose fibres. For example, the pressure drop may be effected by forcing the mixture through an annular opening that has a narrow entrance orifice with a much larger exit orifice. The drastic decrease in pressure as the mixture accelerates into a larger volume (i.e., a lower pressure zone) induces cavitation which causes microfibrillation. In an embodiment, microfibrillation of the fibrous substrate comprising cellulose may be effected in a homogenizer under wet conditions in the presence of the inorganic particulate material. In the homogenizer, the cellulose pulp-inorganic particulate material mixture is pressurized (for example, to a pressure of about 500 bar), and forced through a small nozzle or orifice. The mixture may be pressurized to a pressure of from about 100 to about 1000 bar, for example to a pressure of equal to or greater than about 300 bar, or equal to or greater than about 500, or equal to or greater than about 200 bar, or equal to or greater than about 700 bar. The homogenization subjects the fibres to high shear forces such that as the pressurized cellulose pulp exits the nozzle or orifice, cavitation causes microfibrillation of the cellulose fibres in the pulp. Water may be added to improve flowability of the suspension through the homogenizer. The resulting aqueous suspension comprising microfibrillated cellulose and inorganic particulate material may be fed back into the inlet of the homogenizer for multiple passes through the homogenizer. In a preferred embodiment, the inorganic particulate material is a naturally platy mineral, such as kaolin. As such, homogenization not only facilitates microfibrillation of the cellulose pulp, but also facilitates delamination of the platy inorganic particulate material.

A platy inorganic particulate material, such as kaolin, is understood to have a shape factor of at least about 10, for example, at least about 15, or at least about 20, or at least about 30, or at least about 40, or at least about 50, or at least about 60, or at least about 70, or at least about 80, or at least about 90, or at least about 100. Shape factor, as used herein, is a measure of the ratio of particle diameter to particle thickness for a population of particles of varying size and shape as measured using the electrical conductivity methods, apparatuses, and equations described in U.S. Pat. No. 5,576,617, which is incorporated herein by reference

Optional Components of the Coating Composition

In some embodiments, the composition is formulated for use as an antimicrobial surface coating. In some embodiments, the composition is formulated for use as an antimicrobial surface coating capable of inactivating surface viability of microbes such as bacteria, viruses, and/or fungi.

In some embodiments, the composition is formulated for use as a viral and microbial inactivation surface coating. In some embodiments, the composition is formulated for use as a viral and microbial inactivation surface coating capable of inactivating surface viability of microbes such as bacteria, viruses, and/or fungi.

In some embodiments, the composition comprises an inorganic particulate material. The inorganic particulate material, when present, may, for example, be an alkaline earth metal carbonate or sulphate, such as calcium carbonate, magnesium carbonate, dolomite, gypsum, a hydrous kandite clay such as kaolin, halloysite or ball clay, an anhydrous (calcined) kandite clay such as metakaolin or fully calcined kaolin, talc, mica, perlite or diatomaceous earth, or magnesium hydroxide, or aluminium trihydrate, graphene, graphene oxide, reduced graphene oxide, and mixtures thereof.

In some embodiments, the composition comprises particles of silver, copper, copper oxide, bismuth, cobalt platinum, and mixtures thereof. In some embodiments, the size of the particles may be from 1 nm to 900 In some embodiments, the particles are nanoparticles. In some embodiments, the particles are nanoparticles in the arrangement of core-shell nanoparticles.

In some embodiments, the composition comprises one or more carbon-based nanomaterials (CBNs). In some embodiments, the one or more CBNs comprise one or more of fullerene, carbon dots, graphene, and derivatives thereof. Example fullerene derivatives include, but are not limited to, memethanofullerene, derivative C₆₀ fullerene, bioactive fullerene peptide, functional derivatives of C₆₀ fullerene, bis-functionalized fullerene derivatives bearing two or more solubilizing chains, cationic fullerene derivatives, polycarboxylic fullerene derivatives using chlorofullerene as a precursor, polycarboxylic derivatives of C₇₀ fullerene, and tridecafullerenes appended with up to 360 1,2-mannobiosides. Example carbon dot derivatives include, but are not limited to, boronic-acid-attributed carbon quantum dots, functional carbon quantum dots, benzoxazine-monomer carbon dots, and glycyrrhizic-acid-based carbon dots. Example graphene derivatives include, but are not limited to, multiwalled carbon nanotudes (e.g., pristine multiwalled carbon nanotudes and ox-multiwalled carbon nanotudes), graphene oxide, reduced graphene oxide, graphene oxide/polyvinylpyrrolidone, graphene oxide/poly(diallyldimethylammonium chloride), graphite, graphite oxide, graphene oxide with silver nanoparticles, water-soluble GQD, and graphene platforms with precise dual sulfate/alkyl functionalities.

In some embodiments, the composition comprises microencapsulates that are liquid encapsulated in a shell. In some embodiments, the material for the shell can be either inorganic such as silicate particles or organic such as latex particles.

In some embodiments, the composition comprises Metal-Organic-Framework (MOF).

In some embodiments, the composition comprises one or more hydrogels. In some embodiments, the size of the hydrogel may be from 1 nm to 900 μm. The hydrogel could be prepared using biopolymers such as chitosan, carrageenan, polylactide, or synthetic polymers. The hydrogels could carry stimuli-responsive components that can be triggered by light or humidity.

In some embodiments, the composition comprises a quaternary ammonium compound, such as benzalkonium chloride. In some embodiments, the composition comprises a single or multiple organic biocidal actives.

In some embodiments, the composition comprises one or more bio-based active compounds such as, but not limited to, chitosan and carrageenan.

In some embodiments, the composition comprises functional additives such as fillers, cross-linkers, colorants, optical brightening agents, co-binders, or rheology modifiers, anti-foaming agents or foaming agents, biocides and/or anti-microbial agents.

Preparation of the Coating Composition

In some embodiments, the composition comprising microfibrillated cellulose is prepared by a process of: (i) obtaining a suspension of microfibrillated cellulose in a liquid component, for example water, (ii) adding one or more other liquids to the suspension from step (i) and optionally adding any further components, and optionally (iii) homogenizing the suspension obtained from step (ii).

In some embodiments, the composition comprising nanocellulose (optionally wherein the nanocellulose is microfibrillated cellulose) is prepared by a process of: (i) obtaining a suspension of nanocellulose (optionally wherein the nanocellulose is microfibrillated cellulose) in a liquid component, for example water, (ii) adding one or more other liquids to the suspension from step (i) and optionally adding any further components, and optionally (iii) homogenizing the suspension obtained from step (ii).

Application of the Coating

In some embodiments, the composition is applied to the surface or porous substrate by spray-coating, spin-coating or may also be applied as a spot coating. In some embodiments, the composition is applied to the surface or porous substrate by spray-coating or spin-coating. In some embodiments, the coating is applied to the surface or porous substrate by spray-coating, optionally the spray-coating is applied for example, using a manual atomiser, an aerosol bottle or an industrial spray coater.

In some embodiments, the composition is applied to the surface or porous substrate by drop casting. Drop casting is the formation of a film by dropping a solution/composition onto a surface followed by evaporation of the solution/composition.

In some embodiments, the composition is applied to the porous substrate by soaking the porous substrate in the composition.

In some embodiments, the coating can be applied in one or multiple layers. In some embodiments, the content of each layer applied to the surface or porous substrate may be identical or different in the different layers, i.e. different coating compositions may be used for different layers.

In some embodiments, the coating can be applied in multiple layers by spray-coating, optionally the multiple layers are applied in about 1-100 sprays, or about 30-50 sprays. In some embodiments, the coating is applied to the surface or porous substrate by spray-coating using a manual atomiser. In some embodiments, the content of each layer sprayed onto the surface or porous substrate may be identical or different in the different layers, i.e. different coating compositions may be used for different layers.

In some embodiments, the coating can be applied in multiple layers by drop casting. In some embodiments, the coating can be applied in multiple layers by soaking. In some embodiments, the coating can be applied in multiple layers using a combination of two or more of spray coating, drop casting, and soaking.

Typically, the coating composition that is applied to a surface of an article dries quickly. In some embodiments, the drying time of the coating is in the range of from about 1 s to about 60 s. Such a drying time may avoid bubbles and leads to a surface with optimal surface characteristics.

When applied to the target surface of an article, the disclosed compositions may form a strong external barrier after drying. In some embodiments, the compositions may be dried to form the coating by allowing the liquid in the composition to evaporate optionally at room temperature. In some embodiments, the coating is dried using heat to facilitate faster drying of the composition optionally thereby preventing or mitigating long-term exposure to oxygen and light. In some embodiments, temperatures ranging from about 30° C. to about 35° C. can be used to dry the compositions after they have been applied to a surface or porous substrate. In some embodiments, a hot air drying technique can be used to dry (at least partially) the coating. Such hot air drying techniques can use temperatures ranging from about 60° C. to about 90° C. for a time period ranging from about 2 minutes to about 10 minutes.

In some embodiments, the compositions may be dried to form the coating by allowing the liquid in the composition to evaporate at a temperature of less than about 200° C., or less than about 150° C., or less than about 100° C., or less than about 50° C. or less than about 40° C. In some embodiments, the compositions may be dried to form the coating by allowing the liquid in the composition to evaporate at a temperature less than about 30° C.

In some embodiments, the compositions may be dried to form the coating by allowing the liquid in the composition to evaporate at room temperature. As used herein ‘room temperature’ may refer to a temperature of about 15-25° C. This provides several advantages over use of elevated temperature for instance special apparatus to maintain the drying at an elevated temperature is not required, making a process at room temperature more practical. Alternatively, the compositions may be dried to form the coating by allowing the liquid in the composition to evaporate at a temperature of about 0-30° C., or about 0-15° C., or about 25-30° C.

Coating

In some embodiments, the coating is an antimicrobial surface coating. In some embodiments, the coating is an antiviral surface coating. In some embodiments, the coating is a viral and microbial inactivation surface coating.

In some embodiments, the coating is obtained in the form of a thin layer comprising microfibrillated cellulose. In some embodiments, the coating is obtained in the form of a film comprising microfibrillated cellulose.

In some embodiments, the coating is obtained in the form of a thin layer comprising nanocellulose (optionally wherein the nanocellulose is microfibrillated cellulose). In some embodiments, the coating is obtained in the form of a film comprising nanocellulose (optionally wherein the nanocellulose is microfibrillated cellulose).

In some embodiments, the coating has a thickness of between about 50 and about 5000 nm. In some embodiments, the coating has a thickness of between about 50 and about 2000 nm. In some embodiments, the coating has a thickness of between about 100 and about 1500 nm. In some embodiments, the coating has a thickness of between about 100 and about 1000 nm. In some embodiments, the coating has a thickness of between about 100 and about 500 nm.

In some embodiments, the coating has a thickness of less than about 5000 nm. In some embodiments, the coating has a thickness of less than about 2000 nm. In some embodiments, the coating has a thickness of less than about 1500 nm. In some embodiments, the coating has a thickness of less than about 1300 nm.

In some embodiments, the coating is invisible. As used herein, the term ‘invisible’ refers to the inability for an individual to readily see the coating with the naked eye. In some embodiments, the coating is unnoticeable to the naked eye. In some embodiments, the coating has an opacity of less than about 10%, for example less than about 8%, less than about 5% or less than about 2% (e.g. as measured by an opacimeter or a spectrophotometer).

In some embodiments, the coating comprises microfibrillated cellulose in an amount of about 80 to about 100 wt % based on the total weight of the coating. In some embodiments, the coating comprises microfibrillated cellulose in an amount of about 90 to about 100 wt % based on the total weight of the coating. In some embodiments, the coating comprises microfibrillated cellulose in an amount of about 95 to about 100 wt % based on the total weight of the coating. In some embodiments, the coating comprises microfibrillated cellulose in an amount of about 99 to about 100 wt % based on the total weight of the coating. In some embodiments, the coating consists essentially of microfibrillated cellulose.

In some embodiments, the microfibrillated cellulose content of the coating may be in the range of from about 0.01 to about 99.9 wt % based on the weight of solids of the coating. In some embodiments, the microfibrillated cellulose content of the coating layer may be in the range of about 70 to about 99 wt %, in the range of about 80 to about 99 wt %, or in the range of from about 90 to about 99 wt % based on the weight of the solids of the coating.

In some embodiments, the coating comprises nanocellulose (optionally wherein the nanocellulose is microfibrillated cellulose) in an amount of about 80 to about 100 wt % based on the total weight of the coating. In some embodiments, the coating comprises nanocellulose (optionally wherein the nanocellulose is microfibrillated cellulose) in an amount of about 90 to about 100 wt % based on the total weight of the coating. In some embodiments, the coating comprises nanocellulose (optionally wherein the nanocellulose is microfibrillated cellulose) in an amount of about 95 to about 100 wt % based on the total weight of the coating. In some embodiments, the coating comprises nanocellulose (optionally wherein the nanocellulose is microfibrillated cellulose) in an amount of about 99 to about 100 wt % based on the total weight of the coating. In some embodiments, the coating consists essentially of nanocellulose (optionally wherein the nanocellulose is microfibrillated cellulose).

In some embodiments, the nanocellulose (optionally wherein the nanocellulose is microfibrillated cellulose) content of the coating may be in the range of from about 0.01 to about 99.9 wt % based on the weight of solids of the coating. In some embodiments, the nanocellulose (optionally wherein the nanocellulose is microfibrillated cellulose) content of the coating layer may be in the range of about 70 to about 99 wt %, in the range of about 80 to about 99 wt %, or in the range of from about 90 to about 99 wt % based on the weight of the solids of the coating.

In some embodiments, the coating has a surface porosity of between about 20-70% (of total surface area). In some embodiments, the coating has a porosity of between about 25-65%.

In some embodiments, the coating has a mean pore size of between about 2-20 μm. In some embodiments, the coating has a mean pore size of between about 4-12 μm.

The surface porosity and mean pore size may be measured using a scanning electron microscope (e.g. Philips XL-30 FEG ESEM). Porosity levels can be evaluated using the image processing program (e.g. Gwyddion and the integrated Watershed algorithm).

In some embodiments, the water contact angle of the coating is between about 0° and 180°. In some embodiments, the water contact angle of the coating is between about 0° and 90°. In some embodiments, the water contact angle of the coating is between about 10° and 90°. In some embodiments, the water contact angle of the coating is between about 10° and 45°. In some embodiments, the water contact angle of the coating is about 40° or less. In some embodiments, the water contact angle of the coating is about 35° or less. In some embodiments, the water contact angle of the coating is about 30° or less.

In some embodiments, the water contact angle (°) of the coating is at least about 50% lower than the water contact angle of a corresponding untreated surface.

The water contact angle of the coating may be measured using a generic contact angle goniometer (Ossila Ltd.).

In some embodiments, the coating has a roughness (Rₐ) of between about 50-400 nm. In some embodiments, the coating has a roughness (Rₐ) of between about 5-200 nm. In some embodiments, the coating has a roughness (Rₐ) of between about 200-2000 nm.

In some embodiments, the coating has a waviness (Wₐ) of between about 100-700 nm.

The coating roughness and waviness may be measured using an atomic force microscope (AFM, Multimode, Bruker) with a tapping mode cantilever (NCHR-20, Apex Probes Ltd.). Surface parameters may be extracted from the scans by the AFM and a white light interferometer (WLI).

The term ‘coating’ as used herein refers to a layer of the composition created on the (porous) surface of an article. The layer need not have a uniform thickness or be completely homogenous in composition. Also, the coating need not cover the entire article to which it is applied. In some embodiments, the coating can substantially coat the article. In such embodiments, the coating can cover about 10%, 20%, 30%, 40%, 50%, 60%, 70%, 80%, or 90% of the surface area of the article. In other embodiments, the coating can completely coat the article—that is it can cover about 100% of the object. In some embodiments, the coating can have a thickness that varies by about 10%, 20%, 30%, 40%, 50%, 60%, 70%, 80%, or 90% over the article.

Coating Removal

In some embodiments, the method comprises a step of removing the coating from the surface. In some embodiments, the method comprises a step of the removing the coating from the surface by applying water to the coating.

In some embodiments, the coating is removable from the surface. In some embodiments, the coating is removable from the surface by the application of water to the coating.

Surfaces and Products

In some embodiments, the coating may be applied to one or more surfaces of an article.

In some embodiments, the surface to be treated is non-porous, i.e. the surface is a non-porous surface.

In some embodiments, the surface to be treated is hard, i.e. the surface is a hard surface.

In some embodiments, the surface to be treated is selected from the group consisting of glass, ceramic, wood, metal, paint, plastic and mixtures thereof. In some embodiments, the surface to be treated is selected from the group consisting of glass, ceramic, wood, metal and mixtures thereof. In some embodiments, the surface to be treated may itself be a coating on a surface.

Many surfaces exposed to repeated human contact will benefit from the application of compositions comprising microfibrillated cellulose of the present invention. The surface coating compositions of the present invention will target the public transport sector, including aviation, rail and buses where surfaces are believed to bear high concentrations of viral-laden aerosols, particularly in confined spaces within the foregoing transportation means. The compositions will also be targeted to treat surfaces in medical, business, educational and household settings. For example, the surface coating compositions of the present invention will target surfaces in areas with a high traffic population.

In some embodiments, the surface is a high-touch surface such as counters, shopping carts, table tops, doorknobs, light switches, handles, stair rails, elevator buttons, desks, keyboards, phones, toilets, faucets, and sinks.

### Further Definitions

The titles, headings and subheadings provided herein should not be interpreted as limiting the various aspects of the disclosure. Accordingly, the terms defined below are more fully defined by reference to the specification in its entirety. All references cited herein are incorporated by reference in their entirety.

Unless otherwise defined, scientific and technical terms used herein shall have the meanings that are commonly understood by those of ordinary skill in the art. Further, unless otherwise required by context, singular terms shall include pluralities and plural terms shall include the singular.

In this application, the use of “or” means “and/or” unless stated otherwise. In the context of a multiple dependent claim, the use of “or” refers back to more than one preceding independent or dependent claim in the alternative only.

It is further noted that, as used in this specification and the appended claims, the singular forms “a,” “an,” and “the,” and any singular use of any word, include plural referents unless expressly and unequivocally limited to one referent.

The instant invention is most clearly understood with reference to the following definitions.

The term “about” is used herein to mean approximately. When the term “about” is used in conjunction with a numerical range, it modifies that range by extending the boundaries above and below the numerical values set forth. Illustratively, the use of the term “about” indicates that values slightly outside the cited values, i.e., plus or minus 0.1% to 10%, which are also effective and safe are included in the value. Numerical ranges recited herein by endpoints include all numbers and fractions subsumed within that range (e.g. 1 to 5 includes 1, 1.5, 2, 2.75, 3, 3.90, 4, and 5).

As used herein, the terms “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are inclusive or open-ended and do not exclude additional, unrecited elements or method steps. Additionally, a term that is used in conjunction with the term “comprising” is also understood to be able to be used in conjunction with the term “consisting of” or “consisting essentially of.”

The term “dry” weight is intended to mean the weight of the composition free of liquid, in particular free of water.

As used in the specification and the appended claims, the terms “for example,” “for instance,” “such as,” “including” and the like are meant to introduce examples that further clarify more general subject matter. Unless otherwise specified, these examples are provided only as an aid for understanding the disclosure and are not meant to be limiting in any fashion.

As used herein, the term “include” and its grammatical variants are intended to be non-limiting, such that recitation of items in a list is not to the exclusion of other like items that can be substituted or added to the listed items.

As used herein, the phrase “integer from X to Y” means any integer that includes the endpoints. For example, the phrase “integer from 1 to 5” means 1, 2, 3, 4, or 5.

The term “recycled cellulose-containing materials” means recycled pulp or a papermill broke and/or industrial waste, or paper streams rich in mineral fillers and cellulosic materials from a papermill.

Recitation of ranges of values are merely intended to serve as a shorthand method of referring individually to each separate value falling within the range, unless otherwise indicated, and each separate value is incorporated into the specification as if it were individually recited. The endpoints of all ranges are included within the range and independently combinable.

All method steps described in this disclosure can be performed in any order unless otherwise indicated or otherwise clearly contradicted by context.

The use of any and all examples, or language indicating an example (e.g., “such as”), is intended merely for illustration and does not pose a limitation on the claimed scope unless explicitly claimed. No language in the specification should be construed as indicating any non-claimed element as essential to the practice of the invention.

For the avoidance of doubt, insofar as is practicable any embodiment of a given aspect of the present invention may occur in combination with any other embodiment of the same aspect of the present invention. In addition, insofar as is practicable it is to be understood that any preferred or optional embodiment of any aspect of the present invention should also be considered as a preferred or optional embodiment of any other aspect of the present invention.

The foregoing embodiments and advantages are merely exemplary and are not to be construed as limiting the present invention. Also, the description of the embodiments of the present invention is intended to be illustrative and not to limit the scope of the claims. Many alternatives, modifications, and variations will be apparent to those skilled in the art.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

The various embodiments described in this specification can be combined to provide further embodiments. Aspects of the embodiments can be modified, if necessary to employ concepts of the various patents, applications and publications to provide yet further embodiments.

The disclosures of each and every patent, patent application, publication, and accession number cited herein are hereby incorporated herein by reference in their entirety.

While the present disclosure has been disclosed with reference to various embodiments, it is apparent that other embodiments and variations of these may be devised by others skilled in the art without departing from the true spirit and scope of the disclosure. The appended claims are intended to be construed to include all such embodiments and equivalent variations. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The foregoing written specification is considered to be sufficient to enable one skilled in the art to practice the embodiments. The foregoing description and Examples detail certain embodiments and describes the best mode contemplated by the inventors. It will be appreciated, however, that no matter how detailed the foregoing may appear in text, the embodiment may be practiced in many ways and should be construed in accordance with the appended claims and any equivalents thereof.

### EXAMPLES

Materials

A micro fibrillated cellulose (MFC) aqueous slurry (solid content 0.7 wt. %, 99.9% of the solid content is cellulose, batch code FLD0216-200051) was obtained from FiberLean Technologies Ltd. UK. The MFC was fiber/fibril only MFC.

Polyethyleneimine (PEI; Product code 181978) was obtained from Sigma-Aldrich.

Phosphate buffered saline (PBS; P4417) was obtained from Sigma-Aldrich.

Mucin (Type I-S from bovine submaxillary glands; M3895) was obtained from Sigma-Aldrich.

Bovine Serum Albumin (BSA; A9647) was obtained from Sigma-Aldrich.

Tryptone (T9410) was obtained from Sigma-Aldrich.

Fluorescence dye Alexa Fluor™ 488 C5 Maleimide was obtained from ThermoFisher Scientific.

Glass coverslips (Φ 10 mm, thickness 0.16-0.19 mm) were obtained from Fisher Scientific.

Artificial skin (polyurethane elastomer).

Thin Film Fabrication

Glass coverslips (Φ 10 mm, thickness 0.16-0.19 mm) were cleaned with ethanol and then placed within an oxygen plasma chamber (HPT-100, by Henniker Plasma) for 5 minutes. 70 μl polyethyleneimine solution (1% w/v in H₂O) was placed on the cleaned glass coverslips which were spun at 600 rpm for 30 seconds on a spin coater (SPIN150i, APT GmbH), then accelerated at 500 rpm/s to 4000 rpm and spun for 60 seconds to provide pre-treated glass coverslips.

MFC thin films were fabricated on the pre-treated glass coverslips using two different approaches, namely spin-coating and spray-coating. The MFC aqueous slurry was diluted with ethanol (v/v=1:5) and homogenised (using a SHM1 homogeniser, Stuart) for 3 minutes before use to provide an MFC suspension. In the case of spin coating, 400 μl MFC suspension was added dropwise onto a pre-treated glass coverslip spinning at 6000 rpm. In the case of spray coating, a manual cosmetic atomiser (Avalon, 30 mL, spray dosage 0.16 mL) was used to apply the MFC suspension onto a stationary pre-treated glass coverslip. 40 sprays were made to obtain a high percentage of coverage on the pre-treated surface.

Artificial Salvia Preparation

An artificial salvia solution was prepared in compliance with international standard ASTM E2197 and formed of three types of proteins (i) high molecular weight proteins (Bovine Serum Albumin, BSA), (ii) low molecular weight peptides (tryptone), and (iii) mucous material (mucin).

To prepare the artificial saliva solution, the following solutions were individually prepared: (i) 0.5 g BSA in 10 mL PBS; (ii) 0.5 g tryptone in 10 mL PBS; and (iii) 0.04 g mucin in 10 mL PBS. Each of solutions (i) to (iii) were then passed through a 0.22 μm pore diameter membrane filter, divided into aliquots, and stored at either 4±2° C. (for storage under 24 hours) or −20±2° C. (for storage over 24 hours, followed by thawing before use). 500 μL of the artificial saliva solution was obtained by mixing 25 μL of solution (i), 35 μL of solution (ii), 100 μL of solution (iii), and 340 μL PBS in a container (mixed using a magnetic stirrer for 30 minutes). The concentration of mucin in the resulting artificial saliva solution was 0.8 mg/ml.

Thin Film Characterisation

Surface morphology of the thin films was examined using an atomic force microscope (AFM, Multimode, Bruker) with a tapping mode cantilever (NCHR-20, Apex Probes Ltd.) and a scanning electron microscope (Philips XL-30 FEG ESEM). Surface parameters were extracted from the scans by the AFM and a white light interferometer (WLI). Porosity levels of the thin films were evaluated semi-quantitatively using the image processing program Gwyddion and the integrated Watershed algorithm.

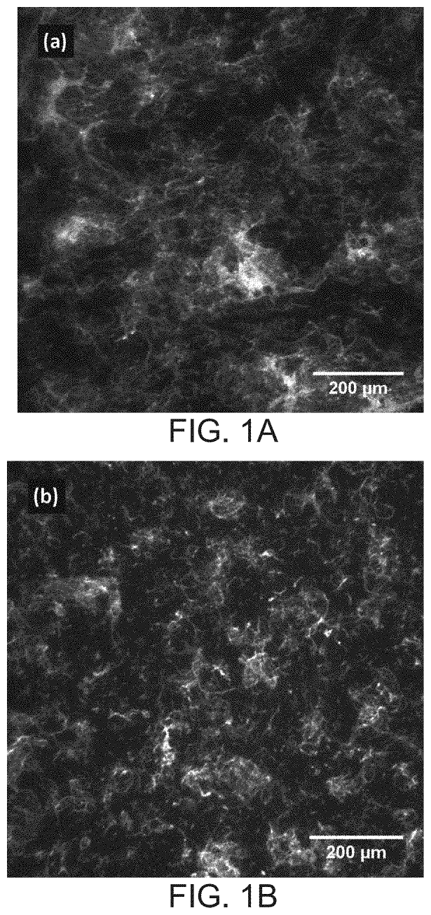

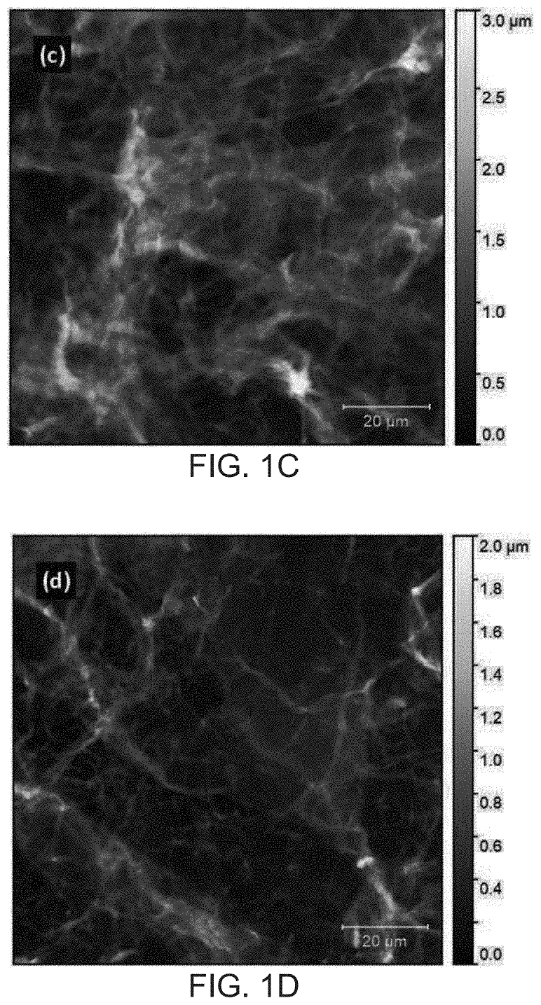

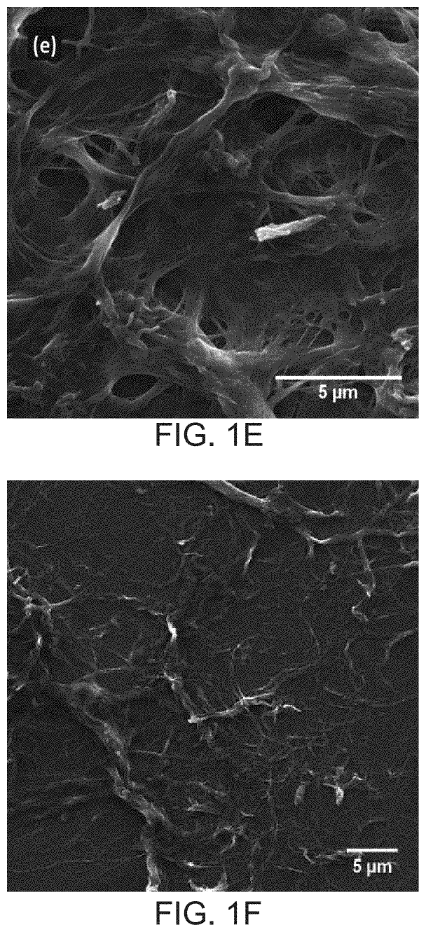

FIG. 1A is an optical microscopic (Leica Z16 APOA) image of an MFC thin film prepared by the herein described spin-coating method.

FIG. 1B is an optical microscopic image of an MFC thin film prepared by the herein described spray-coating method.

FIG. 1C is an atomic force microscopic image of an MFC thin film prepared by the herein described spin-coating method.

FIG. 1D is an atomic force microscopic image of an MFC thin film prepared by the herein described spray-coating method.

FIG. 1E is a scanning electron microscopic image of an MFC thin film prepared by the herein described spin-coating method.

FIG. 1F is a scanning electron microscopic image of an MFC thin film prepared by the herein described spray-coating method.

As shown in FIGS. 1A to 1F, the spray-coating and spin-coating methods both resulted in a good coverage on the pre-treated glass coverslip whilst the density of MFC colonies on the spin-coated MFC thin films is slightly higher than that of those MFC films fabricated by spray-coating. The spin-coated MFC thin films also demonstrate a marginal yet discernible preferred orientation of the fibrils along the radius of the substrate due to the centrifugal effect during spinning. As a comparison, the spray-coated MFC thin films show a more random distribution of the cellulose fibrils.

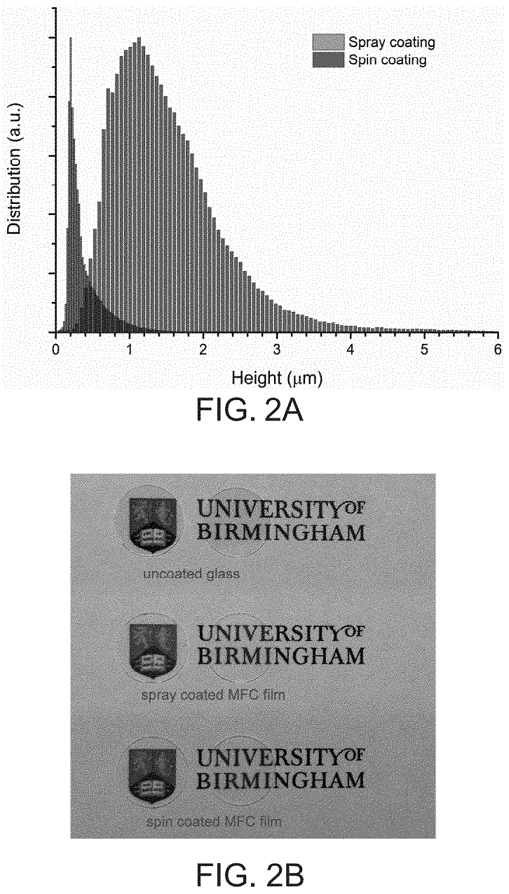

FIG. 2A shows the height distribution of MFC thin films prepared by the herein described spin-coating method and spray-coating method which suggest that the spray-coated MFC thin films and the spin-coated MFC thin films were 300 nm and 1.2 μm thick, respectively, rendering them effectively invisible to the human eye (see FIG. 2B).

Surface parameters such as roughness, waviness and porosity were extracted from surface profile scans and are summarised in Table 1.

TABLE 1

| | Spin-Coated MFC | Spray-Coated MFC |
|---|---|---|
| | Thin Film | Thin Film |
| Roughness Rₐ (nm) | 247 ± 54 | 97 ± 10 |
| Waviness Wₐ (nm) | 460 ± 135 | 144 ± 20 |
| Porosity (% of projected area) | 31.67 ± 6.51 | 58.06 ± 9.16 |
| Mean pore size (μm) | 5.82 ± 0.53 | 10.06 ± 2.30 |

As shown in Table 1, the spin-coated MFC thin films were measured to have a rougher topography, but a lower mean pore size compared to the spray-coated MFC thin films, implying that the former should possess a larger surface area within the MFC architecture.

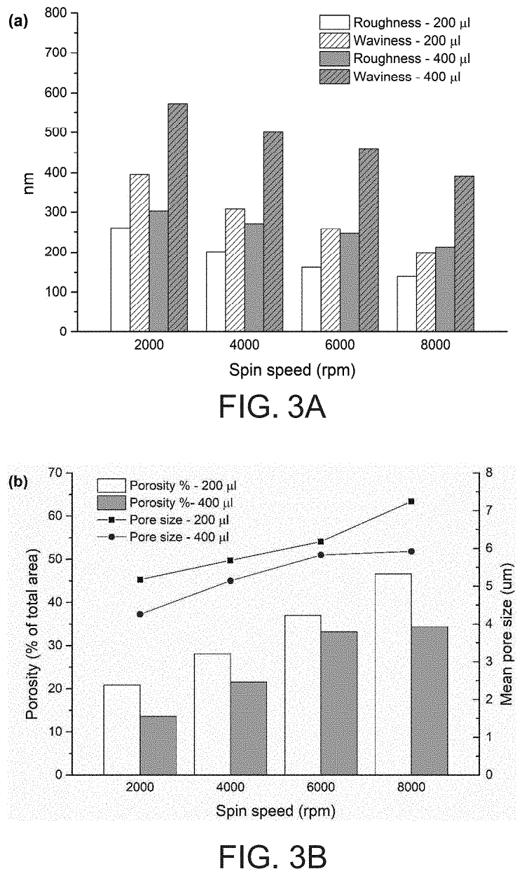

The surface parameters of the MFC thin films can be tuned according to the sample preparation methods. For example, a series of spin-coated MFC thin films were prepared according to the above-described spin-coating method except that the spin speed and amount of MFC suspension was varied. The surface roughness of the spin-coated MFC thin films decreased when the spin speed increased (FIG. 3A). The porosity increased monotonically as a function of the spin speed (FIGS. 3A and 3B). Applying more MFC suspension (200 μl vs. 400 μl) onto the spinning substrate led to higher surface roughness and lower porosity levels (FIGS. 3A and 3B).

### Example 1: MFC Thin Film Mechanical Stability

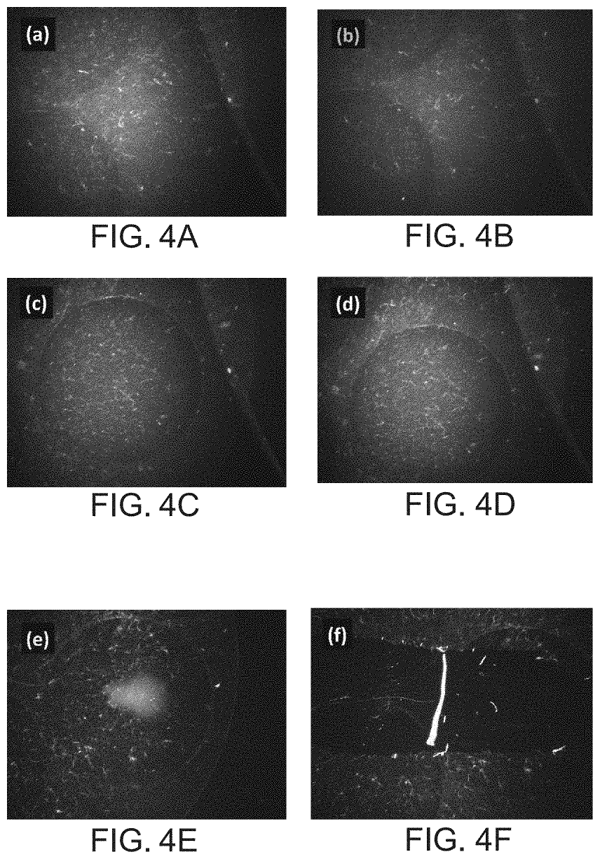

The mechanical stability of the spin coated MFC thin films were evaluated by means of scraping tests against artificial skin using the following methodology. For each of the following tests, an artificial skin piece was fixed on one end of an instrument arm. The artificial skin piece was brought into contact with an MFC thin film and pushed laterally across the MFC thin film with the contact force being kept at either 2 N or 4 N. The distance over which the arm of the force board moved is 25 mm with a speed of 10 mm/s. FIGS. 4A to 4E show the results of the scraping tests using a contact force of 2N. Similar results were obtained using a contact force of 4N.

The first test used a single pass of the artificial skin piece on a dry (i.e. not pre-wetted) MFC thin film. See FIG. 4A which is an optical microscopic image of the MFC thin film before the first test and FIG. 4B showing the same MFC thin film after the first test.

The second test used 17 passes of the artificial skin piece on a dry (i.e. not pre-wetted) MFC thin film. See FIG. 4C which is an optical microscopic image of the MFC thin film before the second test and FIG. 4D showing the same MFC thin film after the second test.

The third test used a single pass of the artificial skin piece on an MFC thin film that had been pre-wetted with artificial saliva droplets (by placing a 0.5 μl droplet of artificial salvia on the film immediately before the test). See FIG. 4E which is an optical microscopic image of the MFC thin film before the third test and FIG. 4F showing the same MFC thin film after the third test.

The morphology of the MFC thin films did not show noticeable removal after the scraping tests with a 2 N load under dry conditions (i.e. for the not pre-wetted MFC thin films), even after multiple cycles of the lateral scraping. The good mechanical stability of the thin film is assigned to the hydrogen bonding between cellulose fibrils and at the cellulose-substrate interface that sufficiently immobilise the network of cellulose fibrils and gives rise to its considerable resistance to occasional scratches while it is dry. However, the MFC thin film was easily removed within a single scraping when it was wetted (only the area of the MFC thin film that had been pre-wetted was removed, the remaining non-wetted area was not removed). The results show that the MFC thin films can be fabricated on common communal surfaces by simply spraying whilst showing good durability in dry, ambient conditions. They can also be removed easily when wetted and re-applied wherever needed during everyday cleaning procedures.

### Example 2.1: Goniometry

For each of the following examples, contact angle measurements were carried out against a droplet size 1 mm in diameter (0.5 μl in volume), for which a generic contact angle goniometer (Ossila Ltd.) was employed.

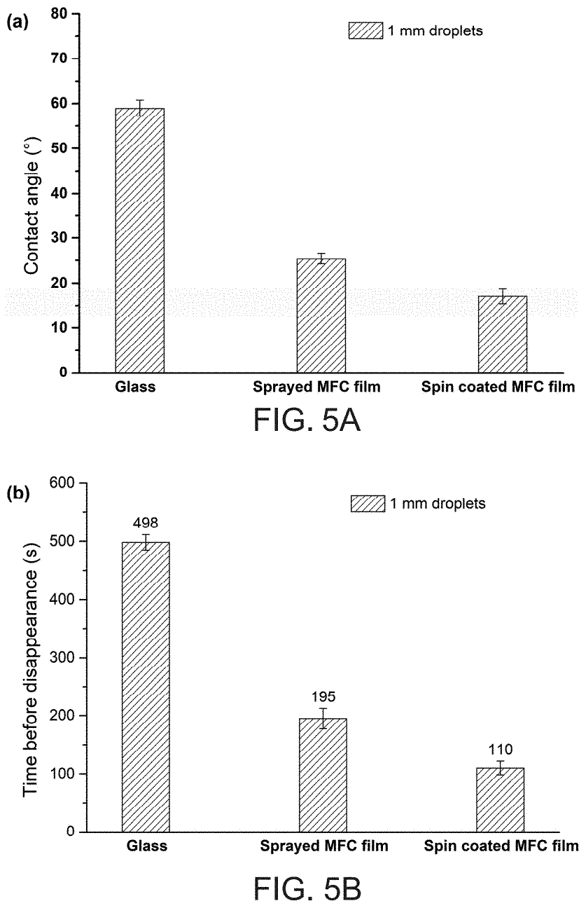

In example 2.1, a 1 mm diameter water droplet was deposited on a pre-cleaned (uncoated) glass coverslip, a spray-coated MFC thin film, and a spin-coated MFC thin film. The water contact angles (dynamic contact angles) were measured 200 milliseconds after deposition of the 1 mm diameter water droplets. The results are shown in FIG. 5A. Additionally, the time until the droplets stopped being discernible to the optics of the goniometer was measured. The results are shown in FIG. 5B.

FIG. 5A shows that MFC thin films fabricated by spray-coating and spin-coating result in significantly reduced contact angles relative to the uncoated glass coverslips (approximately around a half and a third of the contact angle on the uncoated glass coverslip, respectively). This is attributed to the hydrophilic and thus more wettable surface of the MFC.

FIG. 5B shows the time periods during which the droplets were present on the surface (the uncoated glass coverslip, the spray-coated MFC thin film, and the spin-coated MFC thin film) and discernible to the optics of the goniometers. Droplets on solid, flat surfaces (such as the uncoated glass coverslips) simply evaporate over time, whilst droplets deposited on such porous surfaces as the MFC thin films also undergo quick spreading and penetration upon landing. As shown in FIG. 5B, shows that a 1 mm diameter droplet remained detectable for more than 8 minutes (498 seconds) on the uncoated glass coverslip until complete evaporation. In contrast, a 1 mm diameter droplet remained detectable for only approximately 3 minutes (195 seconds) and 2 minutes (110 seconds) on the spray-coated MFC thin film and the spin-coated MFC thin film, respectively. This remarkable reduction demonstrates the MFC thin films can effectively shorten the existing time of aqueous droplets on the surface, hence largely reducing the likelihood foreign surfaces are contaminated by touching the droplet site.

### Example 2.2 QCM Evaporation

The evaporation behavior of droplets of deionized water and the artificial saliva solution were studied using silicon dioxide coated quartz crystal microbalance (QCM) sensors (5 MHz 14 mm Cr/Au/SiO2, Quartz Pro, Sweden). For each of examples 2.2.1 to 2.2.4, the surface of the QCM sensor was (i) the crystal sensor pre-treated in the same way as the above glass coverslips (pre-treated sensor surface); (ii) a spray-coated MFC thin film on a pre-treated sensor surface, or (iii) a spin-coated MFC thin film on a pre-treated sensor surface. The spin-coated MFC thin film and spray-coated MFC thin film were applied to the pre-treated sensor surfaces in the same way that they were applied to the glass coverslips (see Thin Film Fabrication above).

In example 2.2.1, a deionised water droplet of 1 mm in diameter was generated and placed onto each of the QCM sensor surfaces (i) to (iii) by a micropipette.

In example 2.2.2, a droplet of the artificial saliva solution of 1 mm in diameter was generated and placed onto each of the QCM sensor surfaces (i) to (iii) by a micropipette.

In example 2.2.3, aerosol droplets of deionised water (3.0 μm, mass median aerodynamic diameter) were generated and deposited on each of the QCM sensor surfaces (i) to (iii) using a commercially available nebuliser (Omron C28P). The aerosolised droplets were breathed out towards the QCM sensor from a distance of approximately 5 cm at a nebulisation rate of 0.5 mL/min. The duration of each aerosol spit was fixed to be 5 seconds to stimulate sufficient response from the QCM.

In example 2.2.4, aerosol droplets of the artificial saliva solution were generated and deposited each of the QCM sensor surfaces (i) to (iii) using the nubulizer as described in example 2.2.3.

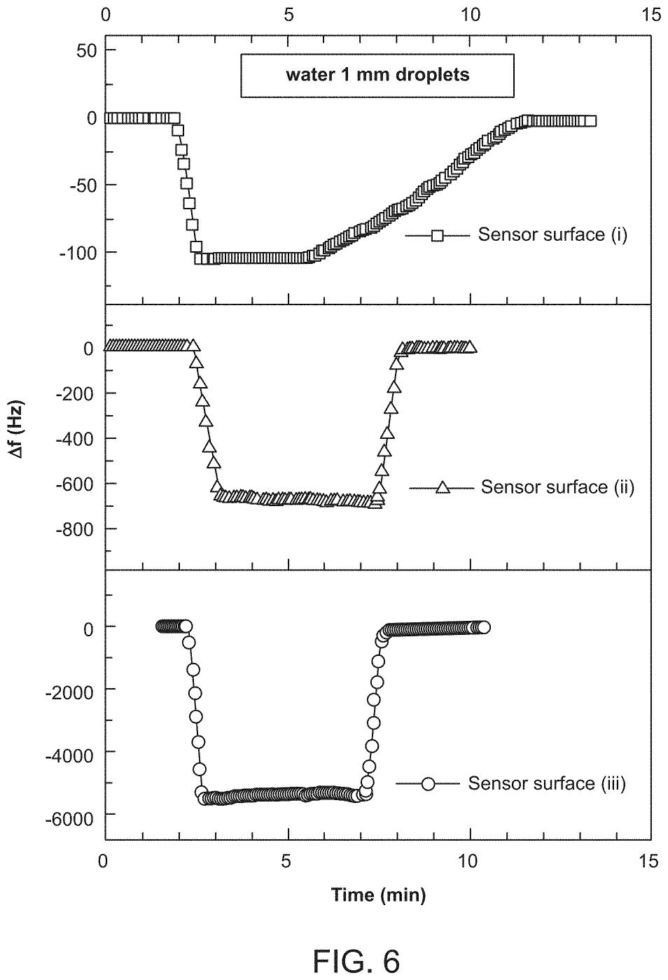

The frequency history of the quartz sensors was recorded throughout the deposition and evaporation of the droplets in examples 2.2.1 to 2.2.4 using a QCM quartz crystal microbalance (openQCM NEXT, Italy). The quartz crystal sensor, upon an applied voltage, is excited to oscillate at its resonance frequency fₒ. The resonant frequency will decrease as a consequence of an adsorbed molecular layer on the crystal surface. Therefore, by looking at the frequency history over time it is possible to identify the moment a droplet was placed on the quartz crystal (frequency dipped) and dried out (frequency recovered). The results are shown in FIGS. 6 to 9 (examples 2.2.1 to 2.2.4, respectively).

FIG. 6 shows the typical evaporation behaviours of 1 mm diameter water droplets on sensor surfaces (i) to (iii). The frequency shift Δf of sensor surface (i) in response to the evaporating water droplet demonstrated three distinct stages: an instant decrease in f from its fundamental value (Δf=100 Hz) when the water droplet is deposited; a plateau of a few minutes during which Δf is relatively constant; a gradual and steady recovery of f up to its original unloaded value (Δf=0 Hz), indicating the completion of the evaporation. The evaporation events on sensor surface (i) last approximately 10 min.

Δf in examples 2.2.1 to 2.2.4 is majorly a measure of the interactions at the solid-liquid interface rather than the total mass change of the spherical cap on top. The second stage of the evaporation on sensor surface (i), where Δf keeps effectively constant, is interpreted as evaporating in the so-called constant contact radius mode. During this stage the contact line is pinned whilst the contact angle and the droplet height decrease as the evaporation continues. The constant contact radius mode lasts until the pinning force, which is a cosine function of the contact angle, is no longer strong enough and the contact line starts to contract, steering the evaporation into the final stage, i.e. a constant contact angle or a mixed mode and resulting in a gradual recovery of the resonant frequency f.

FIG. 6 (example 2.2.1) shows that the ramped recovery of f (due to a largely linear reduction in contact area) on sensor surface (i) was completely cancelled for both sensor surfaces (ii) and (iii). Instead, Δf for sensor surfaces (ii) and (iii) remained unchanged throughout (after the initial decrease) until an abrupt recovery to their unloaded values at the end of the evaporation. This change in the frequency evolution indicates that the contact areas of the 1 mm water droplets on sensor surfaces (ii) and (iii) were effectively constant over their life span. This is ascribed to the MFC thin films that are much more wettable owing to the natural hydrophilicity of the cellulose fibrils and the highly porous structure they form. Meanwhile, the higher surface roughness levels of the MFC thin films (˜100 nm for the spray-coated MFC thin film and ˜250 nm for the spin-coated MFC thin film) gives rise to a larger contact angle hysteresis and complete contact line pinning compared to the uncoated sensor surface.

The MFC thin film coated sensors manifested enormously amplified response (Δf 100 Hz, 700 Hz and 5 kHz for sensor surfaces (i), (ii), and (iii) respectively) to the droplets of the same size. This significantly increased sensitivity to adsorbed mass can also to attributed to the surface roughness introduced by the MFC thin films.

Importantly, FIG. 6 shows that the present MFC thin films shortened the lifetime of 1 mm water drops significantly from around 10 minutes to 3-5 min irrespective of the coating approach. This is understood to be because the water droplets were pinned longer, and their surface area stayed large longer due to the increased surface hydrophilicity, resulting in less time needed for complete evaporation.

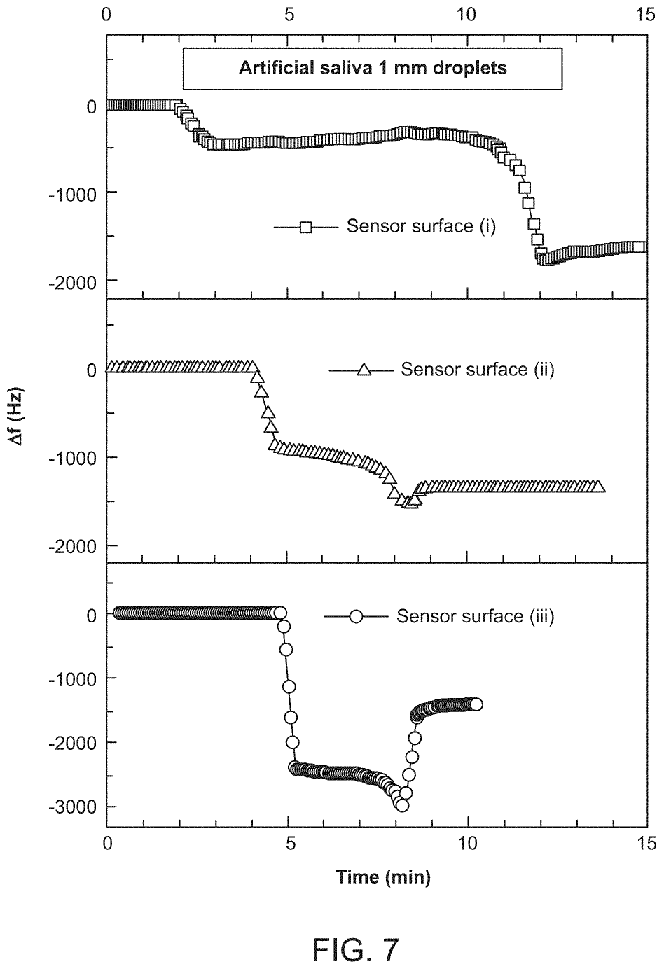

FIG. 7 (example 2.2.2) shows the typical evaporation behaviours of 1 mm diameter artificial saliva droplets on sensor surfaces (i) to (iii). In contrast to FIG. 6, a full recovery to the fundamental frequency is not shown for any of sensor surfaces (i) to (iii). This is because the non-volatile ingredients of the artificial saliva, including mucin proteins and inorganic salt species tend to diffuse towards the three-phase interface and adhere inevitably to the surface at the end of the evaporation. The adsorbed matter finally remaining on the surface upon full dryness is formed of mucin and salt nuclei. As a consequence, the final frequency shifts Δ_{final} upon complete evaporation were similar irrespective of surface configuration (Δ_{final} 1600, 1350, 1400 Hz for sensor surfaces (i) to (iii), respectively).

Similar to example 2.2.1, the evaporation of artificial saliva drops on sensor surface (i) in FIG. 7 shows an initial frequency drop due to the creation of a new solid-liquid interface covering part of the surface area. It is followed by an incubation period of about 6 min as discussed above for the water evaporation in example 2.2.1. The relatively flat Δf suggests that the interfacial adsorption is so far predominated by a water film and the deposition and adsorption of other components (mucin proteins and salts) is negligible at this stage. The frequency then meets the second knee point and turns down gradually when the proteins and salts start to approach the crystal surface. In the finishing stage of the evaporation, the final amount of water is dried out within a short period of time. The mucin and salt masses are pulled down towards the quartz surface by the capillary forces of the evaporating water, causing a rapid decrease in f before stabilising at its final level, i.e., when evaporation completes.

FIG. 7 shows that for both sensor surface (ii) and (iii), the total evaporation time is reduced by over 50%. The time taken for the artificial saliva droplets to dry out remained essentially at the same scale as the water droplets drying on the same surfaces (as in example 2.2.1). Water evaporation is therefore limiting the lifetime of the artificial saliva droplets. The MFC thin films were effective in accelerating the water evaporation as discussed in relation to example 2.2.1.

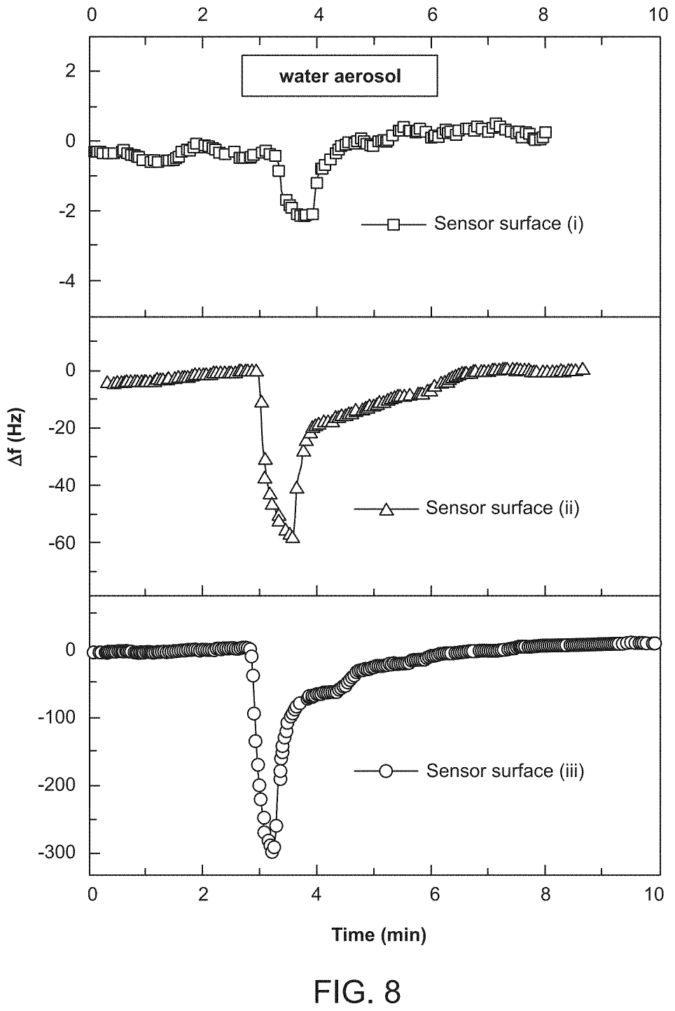

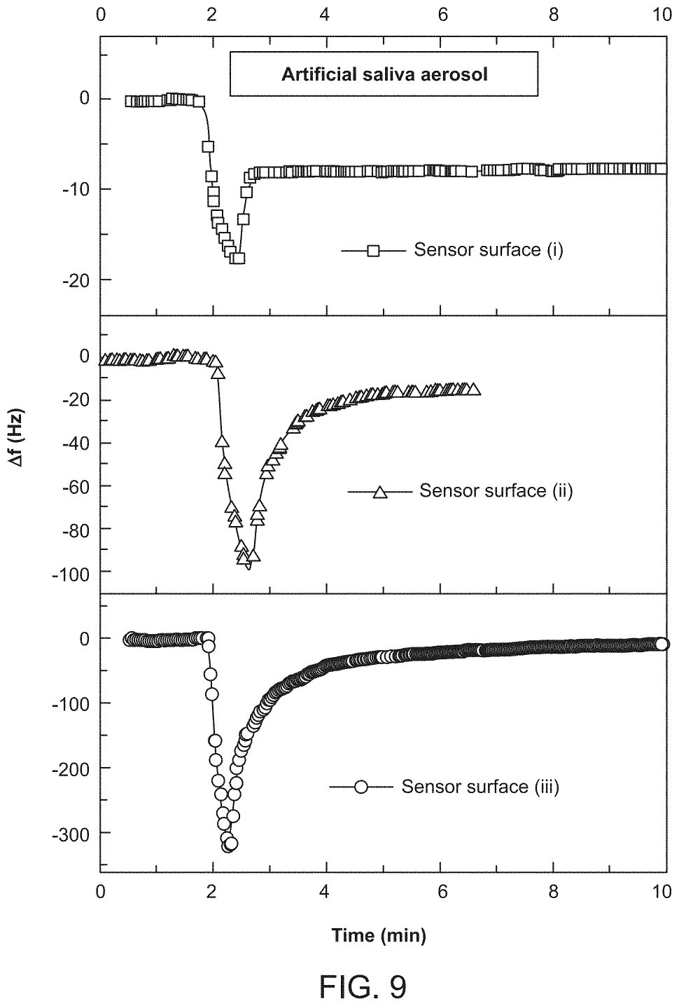

Examples 2.2.3 and 2.2.4 represent dynamic aerosol drying processes. Unlike the 1 mm diameter droplet evaporation in examples 2.2.1 and 2.2.2, all the QCM sensor surfaces show ‘V’ shaped responses (see FIGS. 8 and 9), and no period over which Δf is flat is observed, indicating that no contact line pinning stages occurred. The Δf of all sensor surfaces (i) to (iii) were found ever changing. It is important to note that in examples 2.2.3 and 2.2.4, instead of one single drop (as in examples 2.2.1 and 2.2.2), a large number of aerosolised droplets land on and evaporate from the surfaces over the 5 seconds. Condensation of the aerosolised droplets can also occur at the target substrate given the continuous aerosol flow.

FIGS. 8 and 9 show that the evaporation events on sensor surface (ii) and (iii) last three to four times longer compared to those on sensor surface (i). The longer evaporation time on the MFC coated sensor surfaces is believed to because of the porous structure and increased surface area that leads to a higher uptake of the aerosolised droplets. The aerosolised droplets deployed were effectively smaller than the pore sizes of the spray-coated MFC thin film and the spin-coated MFC thin film (around 10 and 5.8 μm respectively). The MFC films thus trapped more aerosol droplets from the nebulizer, which contributes to their longer evaporation time. This shows that the present MFC thin films are effective in capturing and immobilising free-flight aerosols, including those of respiratory fluid, granting them a high potential towards hygiene and healthcare applications.

### Example 3: Contact Transfer Evaluation

The ability of the MFC thin films to reduce the contact transfer from a surface to a person was evaluated by means of touch tests using artificial skin using the following methodology. For each of the following touch tests, an artificial skin piece was fixed on one end of an instrument arm. The artificial skin piece was driven smoothly towards and into contact with an MFC thin film or pre-treated glass coverslip until a contact force of 2 N was reached. The artificial skin was retracted from the MFC thin film or uncoated glass coverslip smoothly. Each touch cycle lasted approximately 5 seconds.

For each of the following tests, a fluorescent dye (Alexa Fluor 488) was introduced to the artificial saliva.

In example 3.1, a droplet of the fluorescent dye stained artificial saliva solution was deposited on a uncoated glass coverslip. The uncoated glass coverslip loaded with the droplet was immediately subjected to the above touch test.

In example 3.2, a droplet of the fluorescent dye stained artificial saliva solution was deposited on a spray-coated MFC thin film. The MFC thin film loaded with the droplet was immediately subjected to the above touch test.

In example 3.3, a droplet of the fluorescent dye stained artificial saliva solution was deposited on a spin-coated MFC thin film. The MFC thin film loaded with the droplet was immediately subjected to the above touch test.

In example 3.4, a droplet of the fluorescent dye stained artificial saliva solution was deposited on a uncoated glass coverslip. The pre-treated glass coverslip loaded with the droplet was subjected to the above touch test 5 minutes after the droplet was applied to the uncoated glass coverslip.

In example 3.5, a droplet of the fluorescent dye stained artificial saliva solution was deposited on a spray-coated MFC thin film. The MFC thin film loaded with the droplet was subjected to the above touch test 5 minutes after the droplet was applied to the MFC thin film.

In example 3.6, a droplet of the fluorescent dye stained artificial saliva solution was deposited on a spin-coated MFC thin film. The MFC thin film loaded with the droplet was subjected to the above touch test 5 minutes after the droplet was applied to the MFC thin film.

Examples 3.7, 3.8, and 3.9 were conducted using the same methodology as in examples 3.1, 3.2 and 3.3 except that instead of a droplet of the fluorescent dye stained artificial saliva solution, droplets of aerosol (3.0 μm, mass median aerodynamic diameter) of the solution was deposited using a nebulizer (Omron C28P) pointed at the MFC thin film or uncoated glass coverslip from a distance of 5 cm (the nebulizer was turned on for a period of 30 seconds at a nebulization rate of 0.5 mL/min).

Examples 3.10, 3.11, and 3.12 were conducted using the same methodology as in examples 3.4, 3.5 and 3.6 except that instead of a droplet of the fluorescent dye stained artificial saliva solution, droplets of aerosol (3.0 mass median aerodynamic diameter) of the solution was deposited using a nebulizer (Omron C28P) pointed at the MFC thin film or uncoated glass coverslip from a distance of 5 cm (the nebulizer was turned on for a period of 30 seconds at a nebulization rate of 0.5 mL/min).

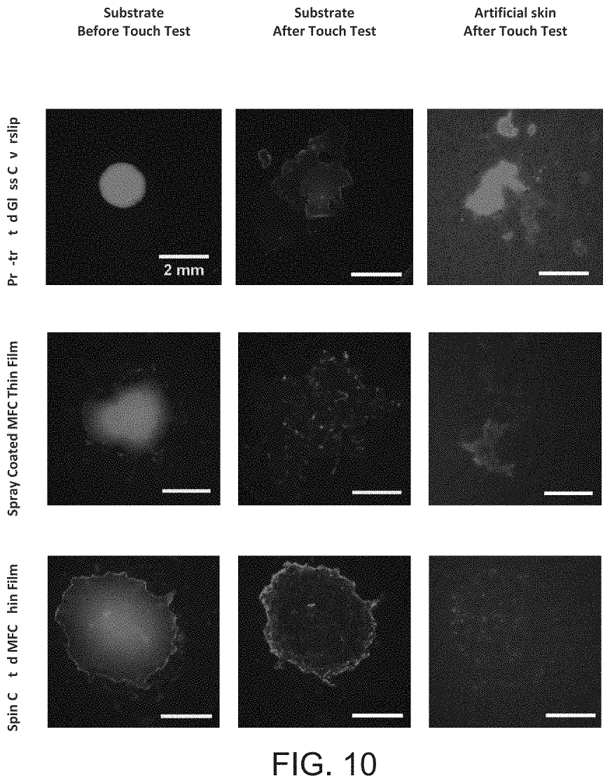

For each of examples 3.1 to 3.9, the MFC thin film/uncoated glass coverslip before the touch test, the MFC thin film/glass coverslip after the touch test and the artificial skin after the touch test were imaged (using a fluorescent microscope: Leica Z16 APOA; 470 nm excitation wavelength). The areas of the fluorescent protein stains after the touch were recorded and analysed using the image processing programme ImageJ and the results are shown in FIGS. 10 to 14.

FIG. 10 shows the redistribution of 1 mm diameter artificial saliva droplets on a substrate (uncoated glass coverslip, spray-coated MFC thin film, or spin-coated MFC thin film) before and after the touch test in examples 3.1, 3.2 and 3.3 as well as the artificial skin after said touch tests.

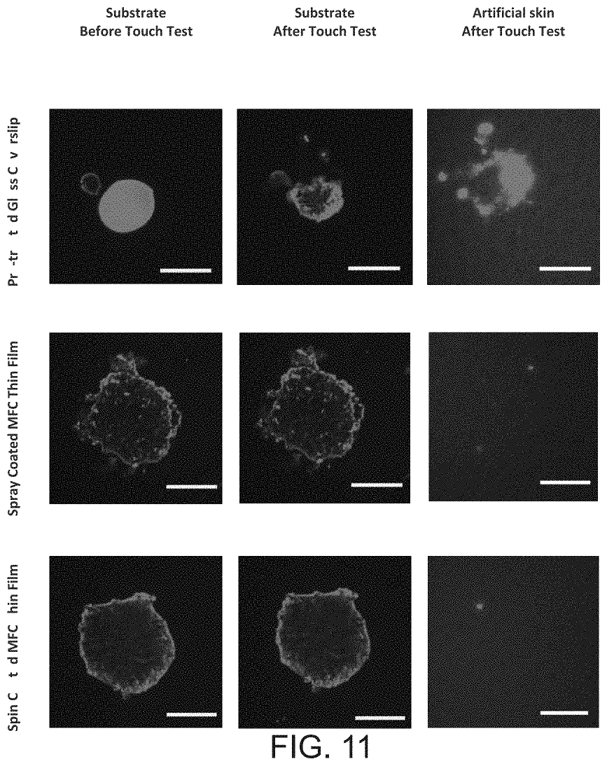

FIG. 11 shows the redistribution of 1 mm diameter artificial saliva droplets on a substrate (uncoated glass coverslip, spray-coated MFC thin film, or spin-coated MFC thin film) before and after the touch test in examples 3.4, 3.5 and 3.6 as well as the artificial skin after said touch tests.

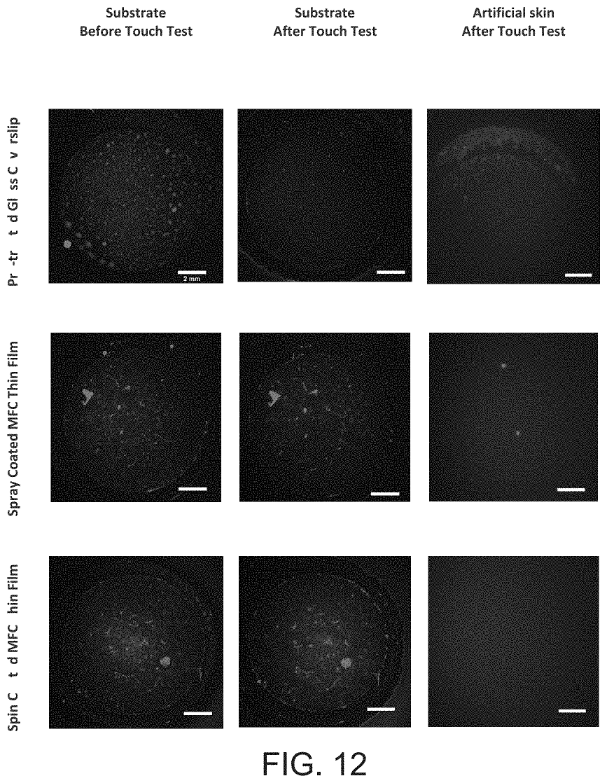

FIG. 12 shows the redistribution of 1 mm diameter artificial saliva droplets on a substrate (uncoated glass coverslip, spray coated MFC thin film, or spin coated MFC thin film) before and after the touch test in examples 3.7, 3.8 and 3.9 as well as the artificial skin after said touch tests.

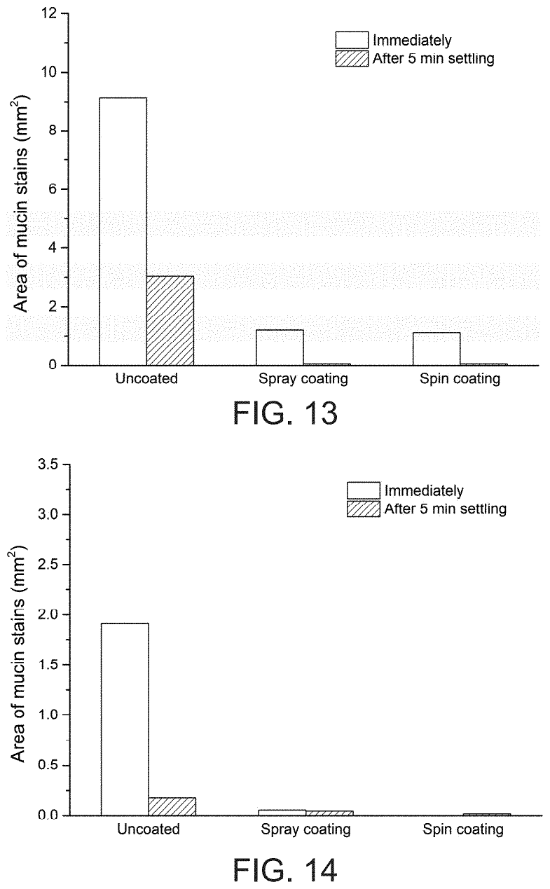

FIG. 13 shows the area of fluorescent stained mucin on the artificial skin following the touch tests in examples 3.1 to 3.6. FIG. 14 shows the area of fluorescent stained mucin on the artificial skin following the touch tests in examples 3.7 to 3.12.

By counting and comparing the areas of artificial skin showing a fluorescent response after contact with the artificial saliva solution on (i) a uncoated glass coverslip; (ii) a spray-coated MFC thin film; and (iii) a spin-coated thin film (FIGS. 10 to 14), it is clearly evidenced that both the spin-coated and spray-coated MFC thin films suppress cross contamination via the back transfer of the mucin (i.e. potentially virus containing) to other surfaces.

FIG. 10 and FIG. 13 show that the spray coated MFC thin film and the spin coated MFC thin film spread the artificial saliva droplets instantly to areas approximately 200% and 400% of that of the same droplet on the uncoated glass coverslip, respectively. The circular droplet on the uncoated glass coverslip was smeared by the artificial skin and left an intense and large area of fluorescence signal on the artificial skin, indicating that a large amount of mucin was collected by the artificial skin during the touch time of 5 seconds. The fluorescence on the artificial skin pieces after pressing against the spray coated MFC thin film and the spin coated MFC thin film attenuated significantly in both intensity and area (an up to 90% reduction in area) relative to the uncoated glass coverslip.

FIG. 11 and FIG. 13 show the transfer of mucin upon contact that was made 5 min after the droplet deposition. The fluorescence on the artificial skin pieces after touching the spray coated MFC thin film and the spin coated MFC thin film attenuated significantly in both intensity and area relative to the uncoated glass coverslip. The artificial skin piece was heavily soiled after touching the uncoated glass coverslip. This is in sharp contrast to the MFC thin films that passed negligible mucin stains onto the artificial skin following the touch test when the droplets were left on for 5 min.

FIG. 12 and FIG. 14 show that the transfer of mucin from the MFC thin films, pre-loaded with artificial saliva aerosol sprays, to the artificial skin is almost zero following the touch tests of examples 3.8, 3.9, 3.11 and 3.12. In contrast, the artificial skin showed large amounts of mucin following contact with the uncoated glass coverside in examples 3.7 and 3.10.

### Example 4: Antimicrobial Testing

In example 4.1, the MFC thin films' ability to inhibit surface transmission of SARS-CoV-2 was studied through in vitro infection of Vero cells. To replicate virus droplets as in a sneeze from an infected person, 0.5 μL drops of medium containing SARS-CoV-2 were added on top of the various materials and left at room temperature for either 5 minutes or 10 minutes. The absorption of the drops was evident immediately in the porous materials. Any remaining infectious virus was then retrieved from the treated surfaces using 50 μl of cell culture medium on top of the viral drops, which were transferred to target cells for infection. We measured infection in Vero cells at 48 hours, by scoring the percentage of spike-expressing cells.

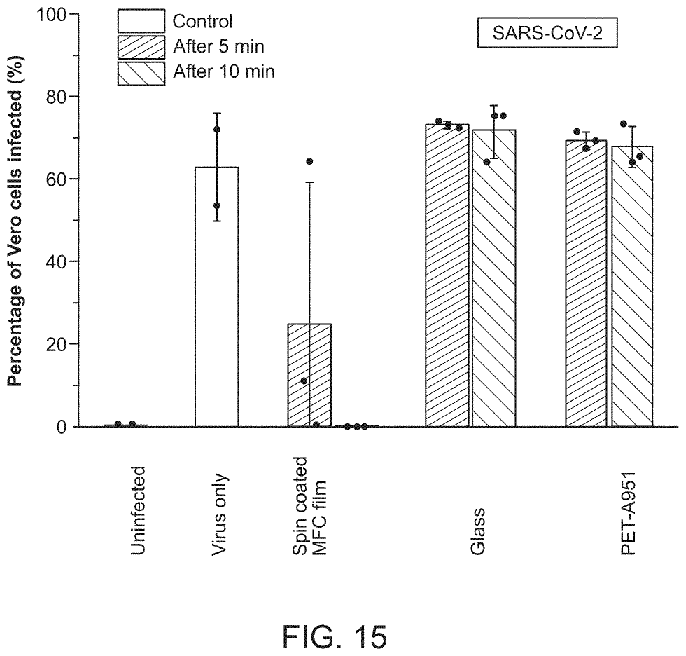

To mimic the formation of surface fomites, virus containing droplets were placed on the surfaces and left settling for 5 or 10 min before the recovery and infection procedures. FIG. 15 shows the effect of the settlement time and surface specification on resultant infection. In case of 5 min, the MFC thin film (spin-coating) of this work has led a threefold reduction in the number of infected cells when compared to the control infection group. The infection rate was further reduced down to low values comparable to the uninfected control group when the virus droplets were left on the MFC coated surface for 10 min prior to recovery. The results suggest that the porous MFC thin film has a clear inactivation effect towards the virus, within a short timeframe of a few minutes after the landing of the virus containing droplets. We interpret this quick and effective virus inactivation primarily as a consequence of the much-accelerated droplet evaporation, as shown in FIGS. 6-9. The droplet of 0.5 uL (the same volume as used in FIGS. 6 and 7) would have been dried out completely after 5 min, leaving the virus content exposed to the ambient environment and prone to disruption and inactivation. In contrast, no adverse effect on the virus viability was found on the glass and polyester surfaces, irrespective of the length of the settling time. The glass and PET materials have been chosen as two representative surfaces that are commonly seen in everyday life. The results in FIG. 15 imply that instead of modulating only the hydrophobicity or hydrophilicity of a surface, creating hydrophilic yet porous surfaces could be a more effective strategy against surface transmission of the virus.

In example 4.2, the MFC thin films' ability to inhibit surface transmission of bacteria was tested. E. coli and S. epidermidis were incubated respectively in 10 ml L-B broth overnight in a 37° C. incubator with shaking at 150 rpm. Both species were pelleted and washed with 10 ml PBS solution twice and suspended in PBS to OD₆₀₀ 0.1 (E. coli: 8.5×10⁷ cells/ml, S. epidermidis: 10.3×10⁷ cells/ml). To the coated slides, 20 μl of the bacterial culture was added, slides were placed in 24 well plates which were sealed with parafilm and incubated at 30° C. for either 1 h or 24 h. After the set amount of time, surviving bacteria were recovered from the slides as follows. (i) Slides were placed into 0.7 ml PBS in 15 ml falcon tubes respectively and vortexed for 30 s. (ii) Slides were further physically scraped with a spatula and the residue mixed into the respective 0.7 ml solution from (i). (iii) Samples were then sonicated for 3×1 min in a bath sonicator (GT Sonic, 40 Hz, 100 W). Serial dilutions were then performed and 10 μl of the final dilution was pipetted onto nutrient agar plates which were left to soak into the agar for 30 mins. Plates were then incubated at 37° C. overnight, after which colonies were counted to determine the antibacterial effect of the coatings.

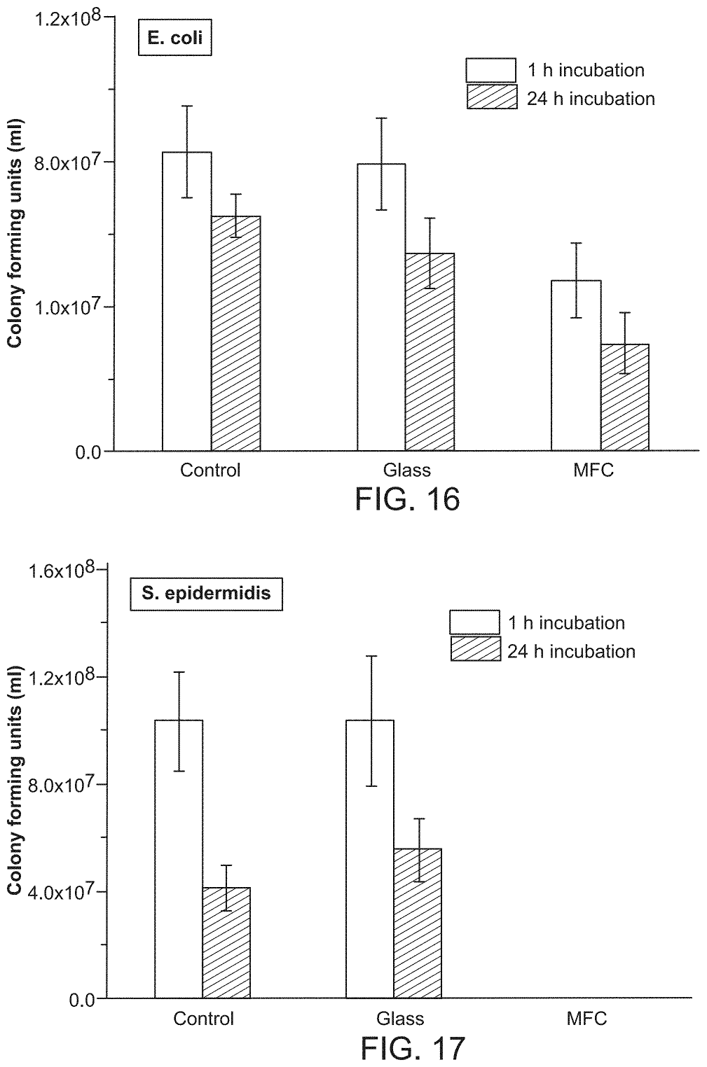

Bacterial testing results using E. coli (FIG. 16) and S.epidermidis (FIG. 17) suggest that the MFC thin film is also able to suppress the proliferation of the two bacteria. Whilst the bare glass surface showed statistically no effect on the viability of both bacteria incubating on its top when compared to the control group, the viability of E. coli was reduced by 43% and 54% when incubating on the MFC thin film for 1 and 24 h, respectively. S. epidermidis is especially vulnerable to the MFC coated substrates, with complete loss of viability after 1 h. The antibacterial effect of the MFC film can be again attributed to its hydrophilicity and porosity. It is known that hydrophilic surfaces can prevent the attachment of bacteria thus the formation of a biofilm due to the presence of a water molecule layer which hinders the adsorption of bacteria. The MFC thin film, in this scenario, enables the generation of a water barrier layer to bacteria adhesion, immediately and uniformly upon the deposition of the bacteria medium.

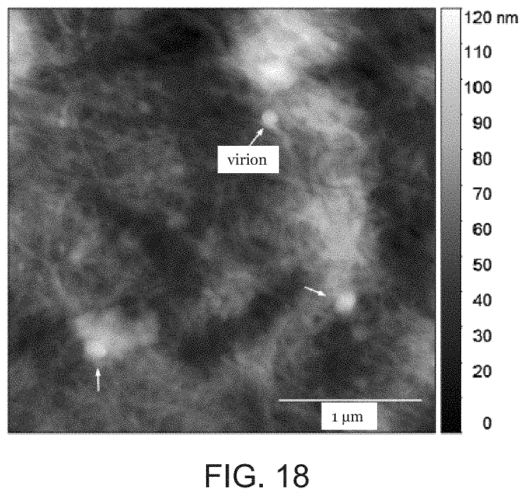

In example 4.3, the MFC thin films' ability to capture an individual SARS-CoV-2 virus was studied. To replicate virus droplets as in a sneeze from an infected person, 0.5 μL drops of medium containing SARS-CoV-2 (England 2 stock 10⁶ IU·mL⁻¹) were added on top of the MFC thin film. Surface morphology of the thin films was examined by an atomic force microscope (AFM, Multimode, Bruker) with a tapping mode cantilever (NCHR-20, Apex Probes Ltd.). FIG. 18 is an atomic force microscopy image of the MFC coating exposed to viral titre showing that the porous coating was able to capture individual virus.

### Example 5.1: Goniometry

For each of the following examples, contact angle measurements were carried out against a droplet size 1 mm in diameter (0.5 μl in volume), for which a generic contact angle goniometer (Ossila Ltd.) was employed.

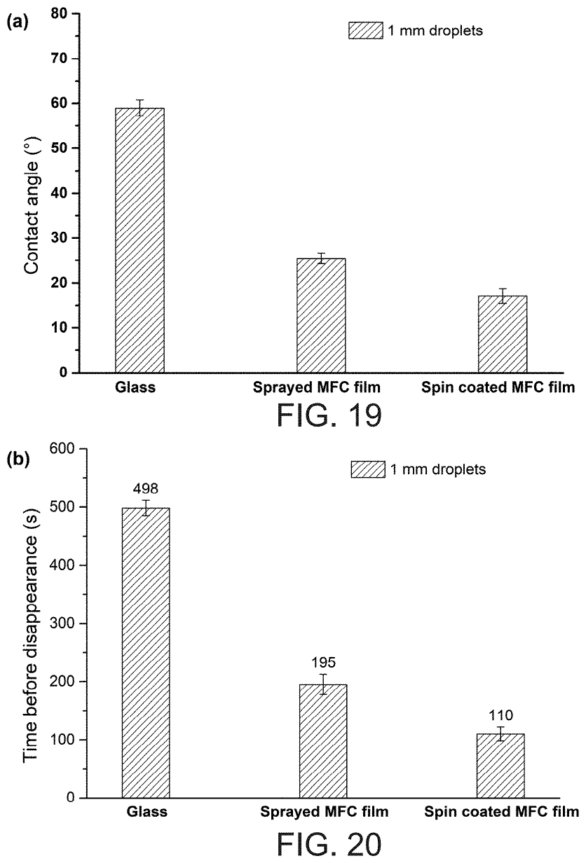

In example 5.1, a 1 mm diameter water droplet was deposited on a pre-cleaned (uncoated) glass coverslip, a spray-coated MFC thin film, and a spin-coated MFC thin film. The water contact angles (dynamic contact angles) were measured 200 milliseconds after deposition of the 1 mm diameter water droplets. The results are shown in FIG. 19. Additionally, the time until the droplets stopped being discernible to the optics of the goniometer was measured. The results are shown in FIG. 20.

FIG. 19 shows that MFC thin films fabricated by spray coating and spin coating result in significantly reduced contact angles relative to the uncoated glass coverslips (approximately around a half and a third of the contact angle on the uncoated glass coverslip, respectively). This is attributed to the hydrophilic and thus more wettable surface of the MFC.

FIG. 20 shows the time periods during which the droplets were present on the surface (the uncoated glass coverslip, the spray-coated MFC thin film, and the spin-coated MFC thin film) and discernible to the optics of the goniometers. Droplets on solid, flat surfaces (such as the uncoated glass coverslips) simply evaporate over time, whilst droplets deposited on such porous surfaces as the MFC thin films also undergo quick spreading and penetration upon landing. As shown in FIG. 20, a 1 mm diameter droplet remained detectable for more than 8 minutes (498 seconds) on the uncoated glass coverslip until complete evaporation. In contrast, a 1 mm diameter droplet remained detectable for only approximately 3 minutes (195 seconds) and 2 minutes (110 seconds) on the spray-coated MFC thin film and the spin-coated MFC thin film, respectively. This remarkable reduction demonstrates the MFC thin films can effectively shorten the existing time of aqueous droplets on the surface, hence largely reducing the likelihood foreign surfaces are contaminated by touching the droplet site.

### Example 5.2 QCM Evaporation

The evaporation behavior of droplets of deionized water and the artificial saliva solution were studied using silicon dioxide coated quartz crystal microbalance (QCM) sensors (5 MHz 14 mm Cr/Au/SiO2, Quartz Pro, Sweden). For each of examples 5.2.1 to 5.2.4, the surface of the QCM sensor was (i) the crystal sensor pre-treated in the same way as the above glass coverslips (pre-treated sensor surface); (ii) a spray-coated MFC thin film on a pre-treated sensor surface, or (iii) a spin-coated MFC thin film on a pre-treated sensor surface. The spin-coated MFC thin film and spray-coated MFC thin film were applied to the pre-treated sensor surfaces in the same way that they were applied to the glass coverslips (see Thin Film Fabrication above).

In example 5.2.1, a deionised water droplet of 1 mm in diameter was generated and placed onto each of the QCM sensor surfaces (i) to (iii) by a micropipette.

In example 5.2.2, a droplet of the artificial saliva solution of 1 mm in diameter was generated and placed onto each of the QCM sensor surfaces (i) to (iii) by a micropipette.

In example 5.2.3, aerosol droplets of deionised water (3.0 μm, mass median aerodynamic diameter) were generated and deposited on each of the QCM sensor surfaces (i) to (iii) using a commercially available nebuliser (Omron C28P). The aerosolised droplets were breathed out towards the QCM sensor from a distance of approximately 5 cm at a nebulisation rate of 0.5 mL/min. The duration of each aerosol spit was fixed to be 5 seconds to stimulate sufficient response from the QCM.

In example 5.2.4, aerosol droplets of the artificial saliva solution were generated and deposited each of the QCM sensor surfaces (i) to (iii) using the nubulizer as described in example 5.2.3.

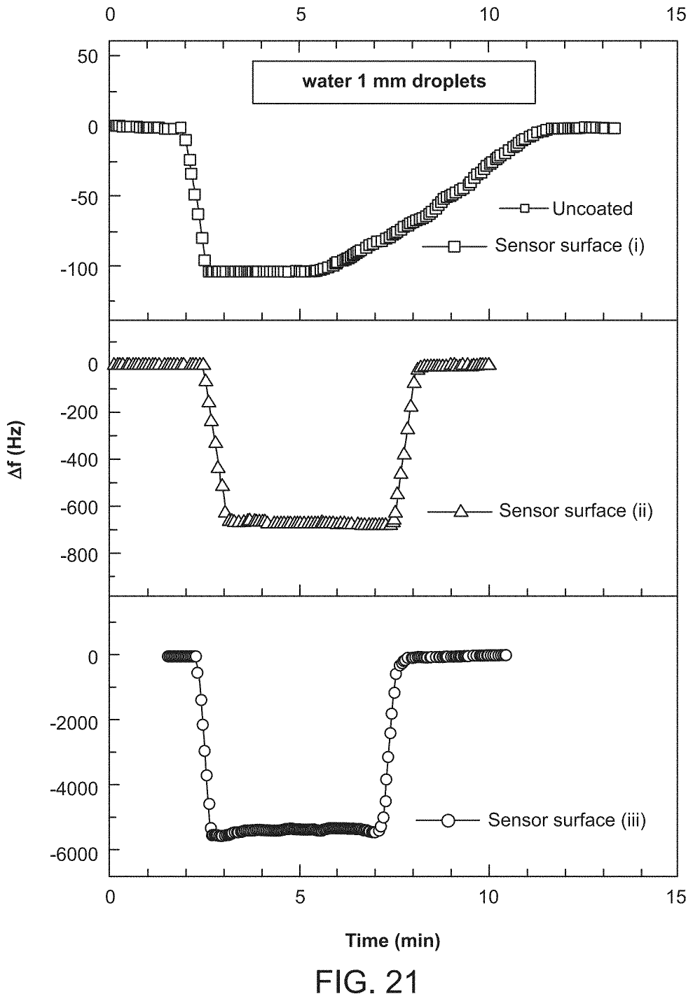

The frequency history of the quartz sensors was recorded throughout the deposition and evaporation of the droplets in examples 5.2.1 to 5.2.4 using a QCM quartz crystal microbalance (openQCM NEXT, Italy). The quartz crystal sensor, upon an applied voltage, is excited to oscillate at its resonance frequency fₒ. The resonant frequency will decrease as a consequence of an adsorbed molecular layer on the crystal surface. Therefore, by looking at the frequency history over time it is possible to identify the moment a droplet was placed on the quartz crystal (frequency dipped) and dried out (frequency recovered). The results are shown in FIGS. 21 to 24 (Examples 5.2.1 to 5.2.4, respectively).

FIG. 21 shows the typical evaporation behaviours of 1 mm diameter water droplets on sensor surfaces (i) to (iii). The frequency shift Δf of sensor surface (i) in response to the evaporating water droplet demonstrated three distinct stages: an instant decrease in f from its fundamental value (Δf=100 Hz) when the water droplet is deposited; a plateau of a few minutes during which Δf is relatively constant; a gradual and steady recovery of f up to its original unloaded value (Δf=0 Hz), indicating the completion of the evaporation. The evaporation events on sensor surface (i) last approximately 10 min.

Δf in examples 5.2.1 to 5.2.4 is majorly a measure of the interactions at the solid-liquid interface rather than the total mass change of the spherical cap on top. The second stage of the evaporation on sensor surface (i), where Δf keeps effectively constant, is interpreted as evaporating in the so-called constant contact radius mode. During this stage, the contact line is pinned whilst the contact angle and the droplet height decrease as the evaporation continues. The constant contact radius mode lasts until the pinning force, which is a cosine function of the contact angle, is no longer strong enough and the contact line starts to contract, steering the evaporation into the final stage, i.e. a constant contact angle or a mixed mode and resulting in a gradual recovery of the resonant frequency f.

FIG. 21 (example 5.2.1) shows that the ramped recovery of f (due to a largely linear reduction in contact area) on sensor surface (i) was completely cancelled for both sensor surfaces (ii) and (iii). Instead, Δf for sensor surfaces (ii) and (iii) remained unchanged throughout (after the initial decrease) until an abrupt recovery to their unloaded values at the end of the evaporation. This change in the frequency evolution indicates that the contact areas of the 1 mm water droplets on sensor surfaces (ii) and (iii) were effectively constant over their life span. This is ascribed to the MFC thin films that are much more wettable owing to the natural hydrophilicity of the cellulose fibrils and the highly porous structure they form. Meanwhile, the higher surface roughness levels of the MFC thin films (˜100 nm for the spray-coated MFC thin film and ˜250 nm for the spin-coated MFC thin film) gives rise to a larger contact angle hysteresis and complete contact line pinning compared to the uncoated sensor surface.

The MFC thin film coated sensors manifested enormously amplified response (Δf 100 Hz, 700 Hz and 5 kHz for sensor surfaces (i), (ii), and (iii) respectively) to the droplets of the same size. This significantly increased sensitivity to adsorbed mass can also to attributed to the surface roughness introduced by the MFC thin films.

Importantly, FIG. 21 shows that the present MFC thin films shortened the lifetime of 1 mm water drops significantly from around 10 minutes to 3-5 min irrespective of the coating approach. This is understood to be because the water droplets were pinned longer, and their surface area stayed large longer due to the increased surface hydrophilicity, resulting in less time needed for complete evaporation.

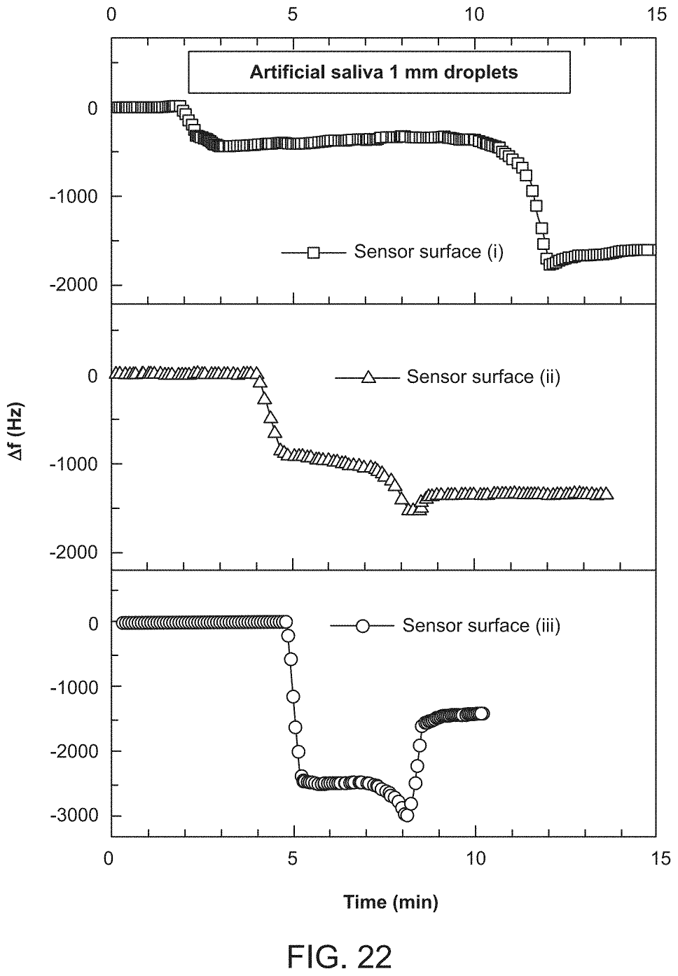

FIG. 22 (example 5.2.2) shows the typical evaporation behaviours of 1 mm diameter artificial saliva droplets on sensor surfaces (i) to (iii). In contrast to FIG. 21, a full recovery to the fundamental frequency is not shown for any of sensor surfaces (i) to (iii). This is because the non-volatile ingredients of the artificial saliva, including mucin proteins and inorganic salt species tend to diffuse towards the three-phase interface and adhere inevitably to the surface at the end of the evaporation. The adsorbed matter finally remaining on the surface upon full dryness is formed of mucin and salt nuclei. As a consequence, the final frequency shifts Δf_{final} upon complete evaporation were similar irrespective of surface configuration Δ_{final} 1600, 1350, 1400 Hz for sensor surfaces (i) to (iii), respectively).

Similar to example 5.2.1, the evaporation of artificial saliva drops on sensor surface (i) in FIG. 22 shows an initial frequency drop due to the creation of a new solid-liquid interface covering part of the surface area. It is followed by an incubation period of about 6 min as discussed above for the water evaporation in example 5.2.1. The relatively flat Δf suggests that the interfacial adsorption is so far predominated by a water film and the deposition and adsorption of other components (mucin proteins and salts) is negligible at this stage. The frequency then meets the second knee point and turns down gradually when the proteins and salts start to approach the crystal surface. In the finishing stage of the evaporation, the final amount of water is dried out within a short period of time. The mucin and salt masses are pulled down towards the quartz surface by the capillary forces of the evaporating water, causing a rapid decrease in f before stabilising at its final level, i.e., when evaporation completes.

FIG. 22 shows that for both sensor surface (ii) and (iii), the total evaporation time is reduced by over 50%. The time taken for the artificial saliva droplets to dry out remained essentially at the same scale as the water droplets drying on the same surfaces (as in example 5.2.1). Water evaporation is therefore limiting the lifetime of the artificial saliva droplets. The MFC thin films were effective in accelerating the water evaporation as discussed in relation to example 5.2.1.

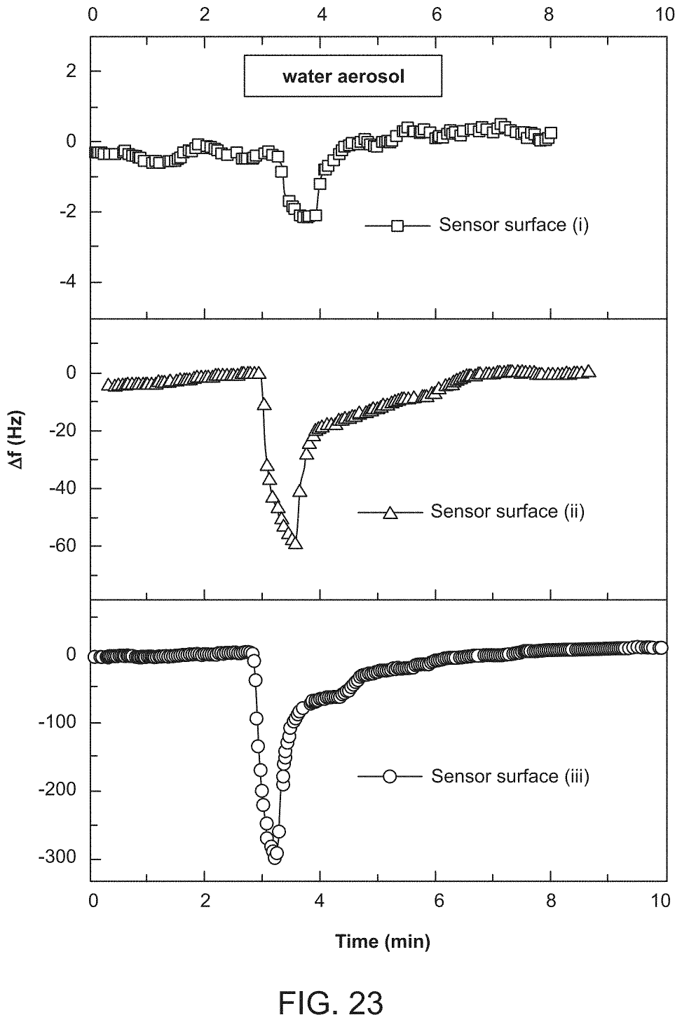

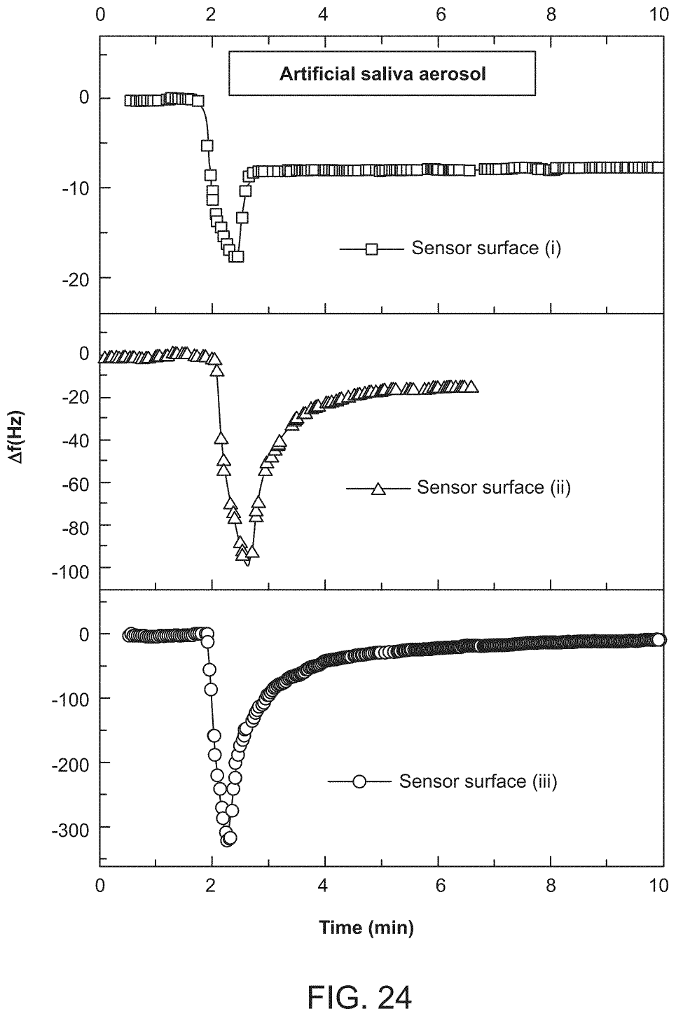

Examples 5.2.3 and 5.2.4 represent dynamic aerosol drying processes. Unlike the 1 mm diameter droplet evaporation in examples 5.2.1 and 5.2.2, all the QCM sensor surfaces show ‘V’ shaped responses (see FIGS. 23 and 24), and no period over which Δf is flat is observed, indicating that no contact line pinning stages occurred. The Δf of all sensor surfaces (i) to (iii) were found ever changing. It is important to note that in examples 5.2.3 and 5.2.4, instead of one single drop (as in examples 5.2.1 and 5.2.2), a large number of aerosolised droplets land on and evaporate from the surfaces over the 5 seconds. Condensation of the aerosolised droplets can also occur at the target substrate given the continuous aerosol flow.

FIGS. 23 and 24 show that the evaporation events on sensor surface (ii) and (iii) last three to four times longer compared to those on sensor surface (i). The longer evaporation time on the MFC coated sensor surfaces is believed to because of the porous structure and increased surface area that leads to a higher uptake of the aerosolised droplets. The aerosolised droplets deployed were effectively smaller than the pore sizes of the spray-coated MFC thin film and the spin-coated MFC thin film (around 10 and 5.8 μm respectively). The MFC films thus trapped more aerosol droplets from the nebulizer, which contributes to their longer evaporation time. This shows that the present MFC thin films are effective in capturing and immobilising free-flight aerosols, including those of respiratory fluid, granting them a high potential towards hygiene and healthcare applications.

### Example 6: Antimicrobial Testing

In example 6.1, the MFC thin films' ability to inhibit surface transmission of SARS-CoV-2 was studied through in vitro infection of Vero cells. To replicate virus droplets as in a sneeze from an infected person, 0.5 μL drops of medium containing SARS-CoV-2 were added on top of the various materials and left at room temperature for either 5 minutes or 10 minutes. The absorption of the drops was evident immediately in the porous materials. Any remaining infectious virus was then retrieved from the treated surfaces using 50 μl of cell culture medium on top of the viral drops, which were transferred to target cells for infection. We measured infection in Vero cells at 48 hours, by scoring the percentage of spike-expressing cells.

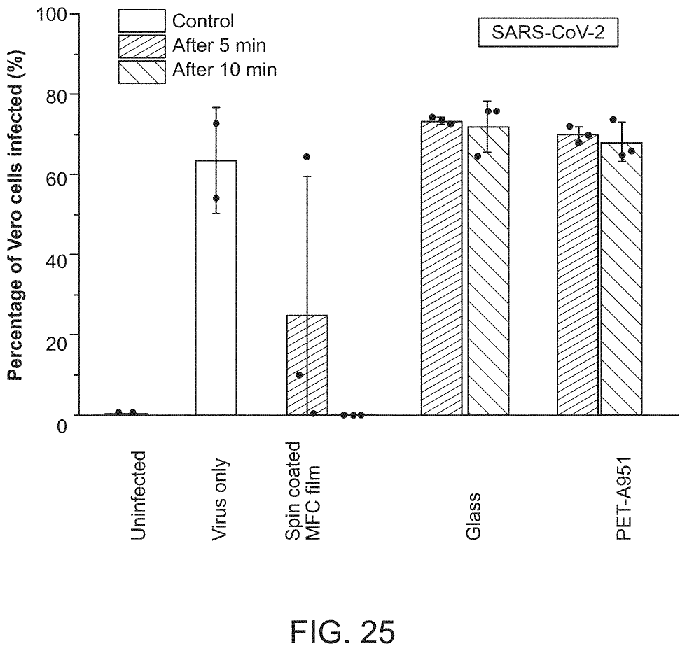

To mimic the formation of surface fomites, virus containing droplets were placed on the surfaces and left settling for 5 or 10 min before the recovery and infection procedures. FIG. 25 shows the effect of the settlement time and surface specification on resultant infection. In case of 5 min, the MFC thin film (spin coating) of this work has led a threefold reduction in the number of infected cells when compared to the control infection group. The infection rate was further reduced down to low values comparable to the uninfected control group when the virus droplets were left on the MFC coated surface for 10 min prior to recovery. The results suggest that the porous MFC thin film has a clear inactivation effect towards the virus, within a short timeframe of a few minutes after the landing of the virus containing droplets. We interpret this quick and effective virus inactivation primarily as a consequence of the much-accelerated droplet evaporation, as shown in FIGS. 21-24. The droplet of 0.5 uL (the same volume as used in FIGS. 21 and 22) would have been dried out completely after 5 min, leaving the virus content exposed to the ambient environment and prone to disruption and inactivation. In contrast, no adverse effect on the virus viability was found on the glass and polyester surfaces, irrespective of the length of the settling time. The glass and PET materials have been chosen as two representative surfaces that are commonly seen in everyday life. The results in FIG. 25 imply that instead of modulating only the hydrophobicity or hydrophilicity of a surface, creating hydrophilic yet porous surfaces could be a more effective strategy against surface transmission of the virus.

In example 6.2, the MFC thin spin coated films' ability to inhibit surface transmission of bacteria was tested. E. coli and S. epidermidis were incubated respectively in 10 ml L-B broth overnight in a 37° C. incubator with shaking at 150 rpm. Both species were pelleted and washed with 10 ml PBS solution twice and suspended in PBS to OD₆₀₀ 0.1 (E. coli: 8.5×10⁷ cells/ml, S. epidermidis: 10.3×10⁷ cells/ml). To the coated slides, 20 μl of the bacterial culture was added, slides were placed in 24 well plates which were sealed with parafilm and incubated at 30° C. for either 1 h or 24 h. After the set amount of time, surviving bacteria were recovered from the slides as follows. (i) Slides were placed into 0.7 ml PBS in 15 ml falcon tubes respectively and vortexed for 30 s. (ii) Slides were further physically scraped with a spatula and the residue mixed into the respective 0.7 ml solution from (i). (iii) Samples were then sonicated for 3×1 min in a bath sonicator (GT Sonic, 40 Hz, 100 W). Serial dilutions were then performed and 10 μl of the final dilution was pipetted onto nutrient agar plates which were left to soak into the agar for 30 mins. Plates were then incubated at 37° C. overnight, after which colonies were counted to determine the antibacterial effect of the coatings.

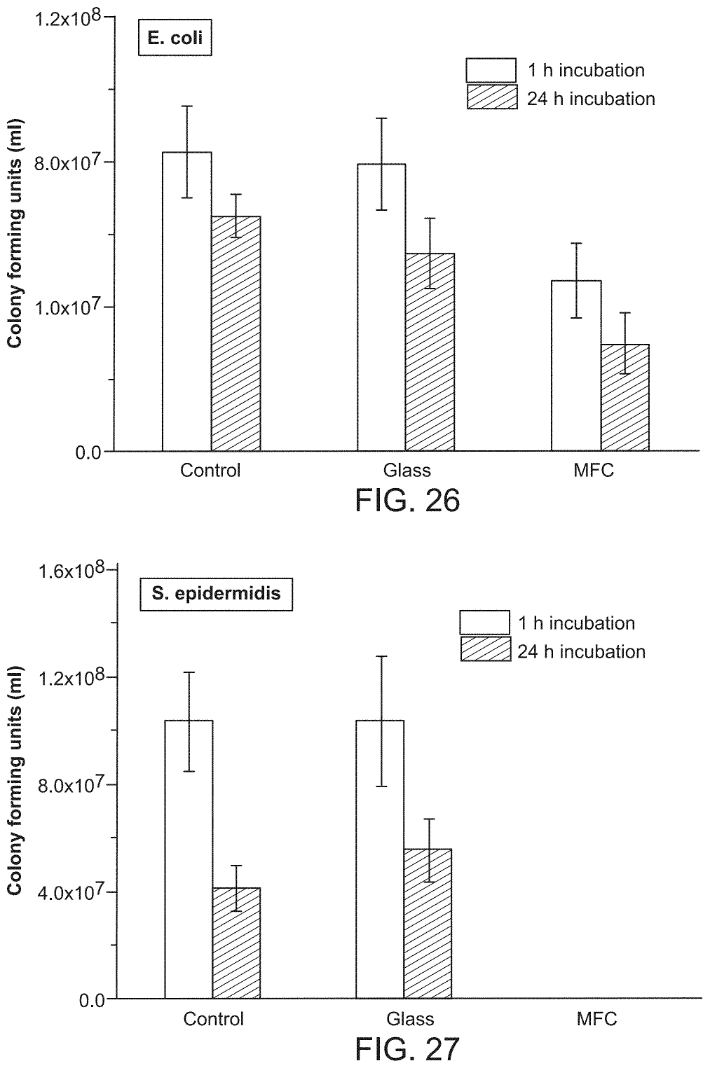

Bacterial testing results using E. coli (FIG. 26) and S. epidermidis (FIG. 27) suggest that the MFC thin film is also able to suppress the proliferation of the two bacteria. Whilst the bare glass surface showed statistically no effect on the viability of both bacteria incubating on its top when compared to the control group, the viability of E. coli was reduced by 43% and 54% when incubating on the MFC thin film for 1 and 24 h, respectively. S. epidermidis is especially vulnerable to the MFC coated substrates, with complete loss of viability after 1 h. The antibacterial effect of the MFC film can be again attributed to its hydrophilicity and porosity. It is known that hydrophilic surfaces can prevent the attachment of bacteria thus the formation of a biofilm due to the presence of a water molecule layer which hinders the adsorption of bacteria. The MFC thin film, in this scenario, enables the generation of a water barrier layer to bacteria adhesion, immediately and uniformly upon the deposition of the bacteria medium.

### Example 7. Breathability/Inhalation Resistance Testing of Coated and Uncoated Cotton and Polyester Material Samples

Measurement Procedure.

The differential pressure (breathability) across 4 material samples was measured following methods set out in BS EN 14683:2019, which is incorporated herein by reference in its entirety, and which specifies construction, design, performance, and test methods for medical face masks intended to limit the transmission of infective agents from staff to patients during surgical procedures and other medical settings with similar requirements.

The 4 samples were denoted as: “Cotton control.” “Cotton coated,” “Polyester control” and “Polyester coated.”

The differential pressure across the samples was measured at 5 points across a nominally 4.9 cm² (25 mm diameter circle) area of the material, with ambient air at a flow rate of nominally 8.01 min-1 being passed through the sample. The 5 points corresponded to nominally the top left, top right, bottom left, bottom right, and centre of the material samples.

The samples were pre-conditioned at nominally 21.0° C. and 85% RH in an environmental chamber for at least 4 hours prior to measurement.

The measurements were performed by laying each sample flat, in-turn, across the sample holder (between the top and bottom parts of the holder). The “coated” samples were places such that the coating was “face-up”, such that air flow would pass though the coating first. The samples were then mechanically clamped in place, before passing ambient air through the sample at nominally 8.0 1 min-1 until the flow rate equilibrated. After which the ambient temperature, humidity and barometric pressure, differential pressure, and flow rate were recorded. The measurements were performed at 5 points across the sample, and results averaged, for each sample.

The differential pressure was measured using a calibrated differential pressure manometer, with the positive and negative inputs of the manometer placed at either side of the sample area under test. The flow rate across the sample was generated using the combination of a vacuum pump, and manual needle valve to restrict the flow. A calibrated mass flow meter with a built-in density conversion was used to measure the volumetric flow rate.

All measurements were made at nominal ambient conditions; a relative humidity of 59±1%, barometric pressure of (1005±1) hPa, and temperature of 19.6±0.1° C.

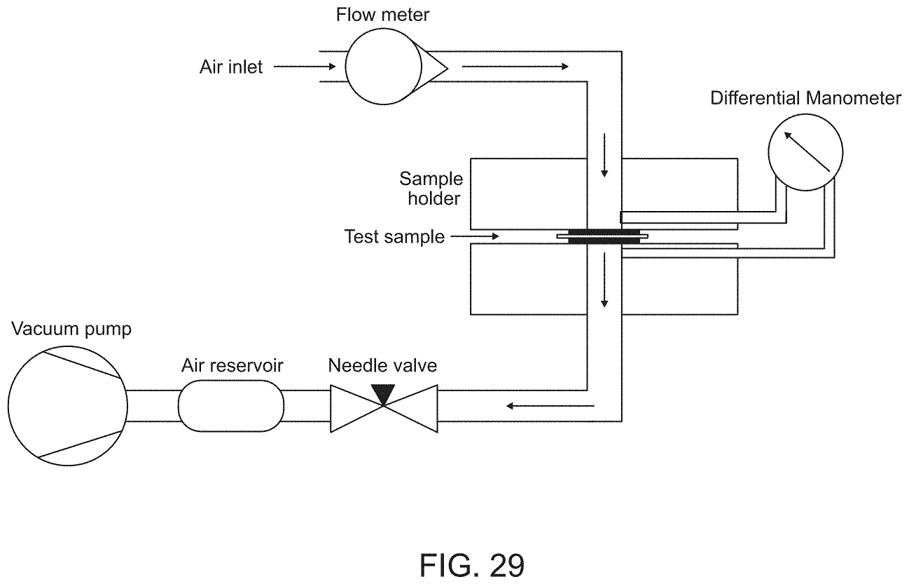

FIG. 29 is a schematic diagram of the measurement equipment used in Example 7.

Results.

The results of the measurements are summarised in Table 2 below.

TABLE 2
Results of the material sample differential pressure measurements

| | Flow | Average | Standard | | |
|---|---|---|---|---|---|
| | rate/1 | differential | Deviation/ | Uncertainty/ | |
| Material under test | min⁻¹ | pressure/Pa | Pa | Pa | k |
| Cotton control | 8.0 | 96.5 | 9.2 | 1.6 | 2.0 |
| Cotton coated | 8.0 | 322.6 | 132.5 | 3.7 | 2.0 |
| Polyester control | 8.0 | 34.2 | 2.8 | 1.3 | 2.0 |
| Polyester coated | 8.0 | 77.0 | 16.4 | 1.5 | 2.0 |

The standard deviation values in Table 2 relates to the variation of measured differential pressure across the 5 measurements points of each sample.

The expanded uncertainty relates to the individual measurements only and does not include any contribution from the variation in measured differential pressure across the sample.

The reported expanded uncertainties in Table 2 are based upon standard uncertainties multiplied by the coverage factor k given in the final column, providing a coverage probability of approximately 95%.

These values include the following type A uncertainties: The reproducibility of the calibrated mass flow meter during the measurements, and the reproducibility of the differential manometer based on prior characterisation, and the following type B uncertainties: the calibration of the mass flow meter, the resolution of the mass flow meter, the area of the test sample, the ambient conditions, the uncertainty of the differential manometer, and the resolution of the differential manometer.

The results and uncertainties given are valid for the specified samples tested and refer to the measurements made during testing only.

### Example 8: Filtration Efficiency Testing of Coated and Uncoated Cotton and Polyester Material Samples

The filtration efficiencies of 4 material samples were tested, using a method based on the method detailed in BS EN 14683:2019.

The 4 samples were denoted as: “Cotton control,” “Cotton coated,” “Polyester control,” and “Polyester coated.”

The test deviated from the methods prescribed in BS EN 14683:2019 in several aspects. Using an ultrasonic mesh nebuliser and an 8% NaCl solution, a challenge aerosol of particles with a calculated Mass Median Stokes Diameter of nominally 3 μm was generated and used in place of a bacterial culture. The aerosol was dispensed at a rate of nominally 0.25 ml min⁺¹ with an air flow of 28.3 1 min⁺¹ through a 7-stage Andersen cascade impactor, created by a vacuum pump. The cascade impactor plates were washed in nominally 250 ml of deionised water and the conductivity of the water measured and used to calculate the mass of salt collected on each plate.

Control runs were performed without test specimens in place; one before and one after testing each set of sample material.

The vacuum pump was activated and the rate of air flow through the cascade impactor adjusted to 28.3 1 min⁺¹. The challenge aerosol was then delivered for nominally 4 minutes. The cascade impactor plates were then washed, in turn, in nominally 250 ml of deionised water. The conductivity of the water and total mass of the solution were recorded. These values were then used to calculate the mass of salt collected on each plate.

The test specimens were measured by first cutting a nominally 80 mm diameter circle from the central section of the sample. Each test specimen was then secured, in turn, by an O-ring inside an additional Stage F between Stage 0 and Stage 1 of the cascade impactor. The “coated” samples were placed such that the coating was “face-up”, such that the challenge aerosol would pass though the coating first. The vacuum pump was activated and the rate of air flow through the cascade impactor adjusted to 28.3 1 min⁺¹. The challenge aerosol was then delivered for nominally 8 minutes. The cascade impactor plates were then washed in turn, in nominally 250 ml of deionised water. The electrical conductivity of the water and total mass of the solution were recorded. These values were then used to calculate the mass of salt collected on each plate.

For each test specimen the filtration efficiency (FE (%)) was calculated according to the following equation:

$$FE ( \% ) = ( 1 - \frac{2 m}{{m}_{c}} ) \times 100 \%$$

where m is the total mass of salt measured and mc is the average of the total masses of salt measured for the two control runs.

The test specimens were pre-conditioned at nominally 21.0° C. and 85% RH in an environmental chamber for at least 4 hours prior to measurement.

Results.

TABLE 3
Results of filtration measurements for the material samples

| Material under test | Filtration efficiency/% | Uncertainty (k = 2)/% |
|---|---|---|
| Cotton control | 71.71 | 1.13 |
| Cotton coated | 86.56 | 0.54 |
| Polyester control | 62.84 | 1.49 |
| Polyester coated | 78.79 | 0.84 |

The reported expanded uncertainties are based upon standard uncertainties multiplied by the coverage factor k=2, providing a coverage probability of approximately 95.

The reported uncertainties include the following type A uncertainties: The short-term reproducibility of the electrical conductivity meter and the short-term reproducibility of the mass balance in the measurements performed, the repeatability of the total control masses, and the following type B uncertainties: the calibration of the electrical conductivity meter, the resolution of the electrical conductivity meter, and the resolution of the mass balance.

The reported uncertainty does not include contributions from the mass flow meter, or concentration of the NaCl solution.

The results and uncertainties given in this report are valid for the specified samples tested and refer to the measurements made during testing only.

### Example 9: Scanning Electron Microscopy (SEM) Images of Porous Surfaces Treated with a Liquid Composition Comprising Microfibrillated Cellulose

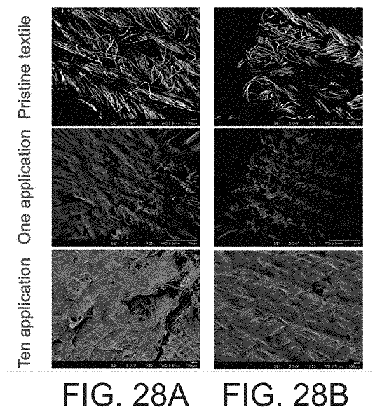

FIG. 28A shows a SEM image of a piece of cotton treated with a liquid composition comprising microfibrillated cellulose. FIG. 28B shows a SEM image of a piece of polyester treated with a liquid composition of microfibrillated cellulose. The porosity between fibres, bundles, and yarns is significantly large to compromise the filtration efficiency of such textile, as opposed to non-woven fabrics that is the core technology for surgical mask. The fabrics show a distinctive surface feature wherein the textile surface is covered by a thin layer of cellulose, which reduces the porosity of the fabric significantly. This is the physical principle enabling the blocking of aerosol droplets containing virus from entering the respiratory system.

Features:

Feature 1. An article comprising a porous substrate having thereon a coating comprising at least about 20 wt % nanocellulose, preferably 20 wt % to 99.5 wt. % based on the total weight of the coating.

Feature 2. The article according to feature 1, wherein the porous substrate is a porous surface of a woven material.

Feature 3. The article according to feature 2, wherein the porous substrate is a woven textile fabric.

Feature 4 The article according to feature 3, wherein the woven textile fabric is a medical textile product.

Feature 5. The article according to feature 4, wherein the medical textile product is a face mask.

Feature 6. The article according to feature 1, wherein the porous substrate is a porous surface of a non-woven material.

Feature 7. The article according to feature 6, wherein the non-woven material is a medical non-woven product.

Feature 8. The article according to feature 7, wherein the medical non-woven product is a face mask.

Feature 9. The article according to feature 1, wherein the porous substrate is a porous surface of a combination of a woven material and a non-woven material.

Feature 10. The article according to feature 9, wherein the woven material is a medical woven material and the non-woven material is a medical non-woven material.

Feature 11. The article according to feature 10, wherein the medical woven material and the medical non-woven material is a face mask.

Feature 12. The article according to feature 1, wherein the nanocellulose comprises cellulose nanofibers.

Feature 13. The article according to feature 1, wherein the nanocellulose comprises nanofibrillated cellulose.

Feature 14. The article according to feature 1, wherein the nanocellulose comprises microfibrillated cellulose.

Feature 15. The article according to feature 1, wherein the nanocellulose comprises cellulose nanocrystals.

Feature 16. The article according to feature 1, wherein the nanocellulose comprises a combination of two or more of cellulose nanofibers, nanofibrillated cellulose, microfibrillated cellulose, and cellulose nanocrystals.

Feature 17. A method of applying a coating to a porous substrate, the method comprising:
(i) treating the porous substrate with a composition comprising a suspension of nanocellulose in a liquid component comprising water; and
(ii) obtaining a porous substrate coated with a coating comprising nanocellulose.

Feature 18. The method according to feature 17, wherein the composition is applied to the porous substrate by spray coating.

Feature 19. The method according to feature 17, wherein the composition is applied to the porous substrate by drop casting.

Feature 20. The method according to feature 17, wherein the composition is applied to the porous substrate by soaking.

Feature 21. The method according to feature 17, wherein after the treatment of step (i), the composition is dried to form the coating by evaporation of the liquid component at room temperature.

Feature 22. The method according to any one of features 17-21, wherein the porous substrate is a porous surface of a woven material.

Feature 23. The method according to feature 22, wherein the woven material is a woven textile fabric.

Feature 24. The method according to feature 23, wherein the woven textile fabric is a medical textile fabric.

Feature 25. The method according to feature 24, wherein the medical textile fabric is a face mask.

Feature 26. The method according to any one of features 17-21, wherein the porous substrate is a porous surface of a non-woven material.

Feature 27. The method according to any one of feature 26, wherein the non-woven material is a medical non-woven material.

Feature 28. The method according to feature 27, wherein the medical non-woven material is a face mask.

Feature 29. The method according to any one of features 17-21, wherein the porous substrate is a porous surface of a combination of a woven material and a non-woven material.

Feature 30. The method according to feature 29, wherein the woven material is a medical woven material and the non-woven material is a medical non-woven material.

Feature 31. The method according to feature 30, wherein the medical woven material and the medical non-woven material is a face mask.

Feature 32. The method according to any one of features 17-31, wherein the nanocellulose comprises cellulose nanofibers.

Feature 33. The method according to any one of features 17-31, wherein the nanocellulose comprises nanofibrillated cellulose.

Feature 34. The method according to any one of features 17-31, wherein the nanocellulose comprises microfibrillated cellulose.

Feature 35. The method according to any one of features 17-31, wherein the nanocellulose comprises cellulose nanocrystals.

Feature 36. The method according to any one of features 17-31, wherein the nanocellulose comprises a combination of two or more of cellulose nanofibers, nanofibrillated cellulose, microfibrillated cellulose, and cellulose nanocrystals.

Feature 37. The method according to feature 34 or 36, wherein the composition comprises microfibrillated cellulose in an amount of about 0.1 to about 10 wt % based on the total weight of the composition.

Feature 38. The method according to feature 37, wherein the composition comprises microfibrillated cellulose in an amount of about 0.1 to about 5 wt % based on the total weight of the composition.

Feature 39. The method according to any one of features 17-38, wherein composition comprises a water miscible component.

Feature 40. The method according to feature 39, wherein the water miscible component is an alcohol.

Feature 41. The method according to any one of features 17-38, wherein the composition comprises one or more water immiscible compounds.

Feature 42. The method according to feature 41, wherein the one or more water immiscible compounds comprises an emulsion formed from oil/wax.

Feature 43. The method according to any one of features 17-42, wherein the composition comprises inorganic particulate materials.

Feature 44. The method according to feature 43, wherein the inorganic particulate material comprises alkaline earth metal carbonate, alkaline earth metal sulphate, dolomite, gypsum, a hydrous kandite clay, an anhydrous calcined kandite clay, talc, mica, perlite, diatomaceous earth, magnesium hydroxide, aluminum trihydrate, or combinations of two or more thereof.

Feature 45. The method according to any one of features 17-44, wherein the composition comprises particles of silver, copper, copper oxide, bismuth, cobalt, platinum, or a mixture thereof.

Feature 46. The method according to any one of features 17-45, wherein the composition comprises carbon-based nanomaterial (CBN).

Feature 47. The method according to feature 46, wherein the CBN comprises fullerene, carbon dots, graphene, derivatives thereof, and combinations of two or more thereof.

Feature 48. The method according to any one of features 17-47, wherein the composition comprises a quaternary ammonium compound.

Feature 49. The method according to any one of features 17-48, wherein the composition comprises one or more bio-based actives.

Feature 50. The method according to feature 49, wherein the one or more bio-based actives comprise one or more of chitosan and carrageenan.

Feature 51. The article or method according to any preceding feature, wherein the coating has an inactivating effect on a microbe capable of causing an infection in a subject.

Feature 52. The article or method according to any preceding feature, wherein the coating has an inactivating effect on a virus capable of causing a viral infection in a subject.

Feature 53. The article or method of feature 52, wherein the virus is an RNA virus selected from the group consisting of a coronavirus (including a coronavirus selected from the group consisting of MERS-CoV, SARS-CoV, and SARS-CoV-2), an influenza virus, a rhinovirus, Measles virus and Mumps virus.

Feature 54. The article or method according to any preceding feature, wherein the coating is obtained in the form of a film.

Feature 55. The article or method according to any preceding feature, wherein the coating has a thickness of between about 50 nm and about 2000 nm.

Feature 56. The article or method according to any preceding feature, wherein the coating has a porosity of between about 20%-70%.

Feature 57. An article comprising a porous substrate coated with a coating applied according to the method of any one of features 17-50.

Feature 58. Use of a composition comprising a suspension of nanocellulose in a liquid component comprising water, and optionally a water miscible component, in a method of preparing a viral and microbial inactivation surface coating.

Feature 59. Use of nanocellulose for inactivating a microbe capable of causing an infection in a subject.

Feature 60. A method of inactivating a microbe capable of causing an infection in a subject, comprising using nanocellulose.

Feature 61. The use or method according to feature 59 or 60, wherein the nanocellulose is in the form of a surface coating.

What is claimed is:

1. An article comprising a surface and having on said surface a coating comprising at least about 80 wt % microfibrillated cellulose based on the total weight of the coating.

2. The article according to claim 1, wherein the surface comprises a non-porous surface optionally selected from the group consisting of glass, ceramic, plastic, wood, metal and mixtures thereof.

3. The article according to claim 1 or claim 2, wherein the surface is a hard surface.

4. A method of applying a coating to a surface, the method comprising:
(i) treating the surface with a composition comprising a suspension of microfibrillated cellulose in a liquid component comprising water and optionally a water miscible component; and
(ii) obtaining a surface coated with a coating comprising microfibrillated cellulose.

5. The method according to claim 4, wherein the composition is applied to the surface by spray-coating.

6. The method according to claim 4 or claim 5, wherein after the treatment of step (i), the composition is dried to form the coating by evaporation of the liquid component at room temperature.

7. The method according to any one of claims 4-6, wherein the surface to be treated comprises a non-porous surface optionally selected from the group consisting of glass, ceramic, plastic, wood, metal and mixtures thereof.

8. The method according to any one of claims 4-7, wherein the surface to be treated is a hard surface.

9. The method according to any one of claims 4-8, wherein the composition comprises microfibrillated cellulose in an amount of about 0.1 to about 10 wt % based on the total weight of the composition, optionally wherein the composition comprises microfibrillated cellulose in an amount of about 0.1 to about 5 wt % based on the total weight of the composition.

10. The method according to any one of claims 4-9, wherein the composition comprises a water miscible component, optionally wherein the water miscible component is an alcohol.

11. The method according to any one of claims 4-10, wherein the composition comprises an inorganic particulate material.

12. The method according to any one of claims 4-11, wherein the composition comprises particles of silver, copper, copper oxide, bismuth, cobalt, platinum or a mixture thereof.

13. The method according to any one of claims 4-12, wherein the composition comprises a quaternary ammonium compound.

14. The article or method according to any preceding claim, wherein the coating has an inactivating effect on a microbe capable of causing an infection in a subject.

15. The article or method according to any preceding claim, wherein the coating has an inactivating effect on a virus capable of causing a viral infection in a subject, optionally wherein the virus is an RNA virus selected from the group consisting of a coronavirus (including a coronavirus selected from the group consisting of MERS-CoV, SARS-CoV, and SARS-CoV-2), an influenza virus, a rhinovirus, Measles virus and Mumps virus.

16. The article or method according to any preceding claim, wherein the coating is obtained in the form of a film.

17. The article or method according to any preceding claim, wherein the coating has a thickness of between about 50 and about 2000 nm.

18. The article or method according to any preceding claim, wherein the coating is invisible.

19. The article or method according to any preceding claim, wherein the coating has a porosity of between about 20-70%.

20. The article or method according to any preceding claim, wherein the water contact angle (°) of the coating is at least about 50% lower than the water contact angle of a corresponding untreated surface.

21. The article or method according to any preceding claim, wherein the microfibrillated cellulose has a fibre steepness of from about 20 to about 50.

22. The article or method according to any preceding claim, wherein the microfibrillated cellulose has a d₅₀ ranging from about 5 μm to about 500 μm.

23. An article comprising a surface coated with a coating applied according to the method of any one of claims 4-22.

24. Use of a composition comprising a suspension of microfibrillated cellulose in a liquid component comprising water, and optionally a water miscible component, in a method of preparing an antimicrobial surface coating.

25. Use of microfibrillated cellulose for inactivating a microbe capable of causing an infection in a subject.

26. A method of inactivating a microbe capable of causing an infection in a subject, comprising using microfibrillated cellulose.

27. The use or method according to claim 25 or claim 26, wherein the microfibrillated cellulose is in the form of a surface coating.

28. The use or method according to claim 27, wherein the surface coating is invisible.

29. An article comprising a porous substrate having thereon a coating comprising at least about 20 wt % nanocellulose, preferably 20 wt % to 99.5 wt. % based on the total weight of the coating.

30. The article according to claim 29, wherein the porous substrate is a porous surface of a woven material; optionally wherein the woven material is a woven textile fabric; optionally wherein the woven textile fabric is a medical textile fabric; optionally wherein the medical textile fabric is a face mask.

31. The article according to claim 29, wherein the porous substrate is a porous surface of a non-woven material; optionally wherein the non-woven material is a medical non-woven material; optionally wherein the medical non-woven material is a face mask.

32. The article according to claim 29, wherein the porous substrate is a porous surface of a combination of a woven material and a non-woven material; optionally wherein the woven material is a medical woven material and the non-woven material is a medical non-woven material; optionally wherein the medical woven material and the medical non-woven material is a face mask.

33. The article according to claim 29, wherein the nanocellulose is selected from the group consisting of cellulose nanofibers, nanofibrillated cellulose, microfibrillated cellulose, cellulose nanocrystals, or combinations thereof; optionally wherein the nanocellulose is microfibrillated cellulose.

34. A method of applying a coating to a porous substrate, the method comprising:
(i) treating the porous substrate with a composition comprising a suspension of nanocellulose in a liquid component comprising water; and
(ii) obtaining a porous substrate coated with a coating comprising nanocellulose.

35. The method according to claim 34, wherein the composition is applied to the porous substrate by one of spray coating, drop casting, or soaking.

36. The method according to claim 34 or 35, wherein after the treatment of step (i), the composition is dried to form the coating by evaporation of the liquid component at room temperature.

37. The method according to any one of claims 34-36, wherein the porous substrate is a porous surface of a woven material; optionally the woven material is a woven textile fabric; optionally wherein the woven textile fabric is a medical textile fabric; optionally wherein the medical textile fabric is a face mask.

38. The method according to any one of claims 34-36, wherein the porous substrate is a porous surface of a non-woven material; optionally wherein the non-woven material is a medical non-woven material; optionally wherein the medical non-woven material is a face mask.

39. The method according to any one of claims 34-36, wherein the porous substrate is a porous surface of a combination of a woven material and a non-woven material; optionally wherein the woven material is a medical woven material and the non-woven material is a medical non-woven material; optionally wherein the medical woven material and the medical non-woven material is a face mask.

40. The method according to any one of claims 34-39, wherein the nanocellulose is selected from the group consisting of cellulose nanofibers, nanofibrillated cellulose, microfibrillated cellulose, cellulose nanocrystals, or combinations thereof; optionally wherein the nanocellulose is microfibrillated cellulose.

41. The method according to claim 40, wherein the composition comprises microfibrillated cellulose in an amount of about 0.1 to about 10 wt % based on the total weight of the composition; optionally wherein the composition comprises microfibrillated cellulose in an amount of about 0.1 to about 5 wt % based on the total weight of the composition.

42. The method according to any one of claims 34-41, wherein composition comprises a water miscible component; optionally wherein the water miscible component is an alcohol.

43. The method according to any one of claims 34-42, wherein the composition comprises one or more water immiscible compounds; optionally wherein the one or more water immiscible compounds comprises an emulsion formed from oil/wax.

44. The method according to any one of claims 34-43, wherein the composition comprises alkaline earth metal carbonate, alkaline earth metal sulphate, dolomite, gypsum, a hydrous kandite clay, an anhydrous calcined kandite clay, talc, mica, perlite, diatomaceous earth, magnesium hydroxide, aluminum trihydrate, or combinations thereof.

45. The method according to any one of claims 34-44, wherein the composition comprises particles of silver, copper, copper oxide, bismuth, cobalt, platinum, or a mixture thereof.

46. The method according to any one of claims 34-45, wherein the composition comprises carbon-based nanomaterial (CBN); optionally wherein the CBN comprises fullerene, carbon dots, graphene, derivatives thereof, or combinations of thereof.

47. The method according to any one of claims 34-46, wherein the composition comprises a quaternary ammonium compound.

48. The method according to any one of claims 34-47, wherein the composition comprises one or more bio-based actives; optionally wherein the one or more bio-based actives comprise one or more of chitosan and carrageenan.

49. The article or method according to any preceding claim, wherein the coating has an inactivating effect on a microbe capable of causing an infection in a subject; optionally wherein the coating has an inactivating effect on a virus capable of causing a viral infection in a subject; optionally wherein the virus is an RNA virus selected from the group consisting of a coronavirus (including a coronavirus selected from the group consisting of MERS-CoV, SARS-CoV, and SARS-CoV-2), an influenza virus, a rhinovirus, Measles virus and Mumps virus.

50. The article or method according to any preceding claim, wherein the coating is obtained in the form of a film; optionally wherein the coating has a thickness of between about 50 nm and about 2000 nm and/or wherein the coating has a porosity of between about 20%-70%.

51. An article comprising a porous substrate coated with a coating applied according to the method of any one of claims 34-50.

52. Use of a composition comprising a suspension of nanocellulose in a liquid component comprising water, and optionally a water miscible component, in a method of preparing a viral and microbial inactivation surface coating.

53. A method of inactivating a microbe capable of causing an infection in a subject, comprising using nanocellulose; optionally wherein the nanocellulose is in the form of a surface coating.
